(19) United States
(12) Patent Application Publication
(10) Pub. No.: US 2025/0055638 A1
(43) Pub. Date: Feb. 13, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zhe LIU, Dongguan (CN); Wenhong CHEN, Dongguan (CN); Yun FANG, Dongguan (CN)

(21) Appl. No.: 18/932,261

(22) Filed: Oct. 30, 2024

Related U.S. Application Data
(63) Continuation of application No. PCT/CN2022/105943, filed on Jul. 15, 2022.

(51) Int. Cl. H04L 5/00

(52) U.S. Cl. CPC H04L 5/0051

(57) ABSTRACT

A wireless communication method includes: determining port information of a DMRS and/or transmission layer number information of a plurality of uplink information according to target antenna port indication information, where the plurality of uplink information is associated with different spatial parameters, and the plurality of uplink information includes first uplink information and second uplink information.

### CROSS-REFERENCE TO RELATED APPLICATION

This application is a Continuation Application of International Application No. PCT/CN2022/105943 filed on Jul. 15, 2022, which is incorporated herein by reference in its entirety.

### TECHNICAL FIELD

Embodiments of the present application relate to the field of communication, and in particular, to a wireless communication method, a terminal device, and a network device.

### BACKGROUND

In the related technologies, a demodulation reference signal (DMRS) of uplink information may be used for channel estimation and demodulation of the uplink information. A port of a DMRS for transmitting an uplink signal is configured by a network device.

In some scenarios, a plurality of transmission schemes for a Physical Uplink Shared Channel (PUSCH) of multi-antenna panels are introduced. In this scenario, how a terminal device determines the demodulation reference signal (DMRS) port and the number of transmission layers of the PUSCH transmitted by each panel to improve the transmission performance, is a problem that needs to be solved.

### SUMMARY

The present application provides a wireless communication method, a terminal device, and a network device.

In a first aspect, a wireless communication method is provided, and includes: determining, by a terminal device, port information of a demodulation reference signal (DMRS) and/or transmission layer number information of a plurality of uplink information according to target antenna port indication information, where the plurality of uplink information is associated with different spatial parameters, and the plurality of uplink information includes first uplink information and second uplink information.

In a second aspect, a wireless communication method is provided, and includes: determining, by a network device, port information of a demodulation reference signal (DMRS) and/or transmission layer number information of a plurality of uplink information, where the plurality of uplink information is associated with different spatial parameters, and the plurality of uplink information includes first uplink information and second uplink information; and transmitting target antenna port indication information to a terminal device, where the target antenna port indication information is used by the terminal device to determine the port information of the DMRS and/or the transmission layer number information of the plurality of uplink information.

In a third aspect, a terminal device is provided for performing the method in the above first aspect or its various implementations.

In some embodiments, the terminal device includes a functional module for performing the method in the above first aspect or its various implementations.

In a fourth aspect, a network device is provided for performing the method in the above second aspect or its various implementations.

In some embodiments, the network device includes a functional module for performing the method in the above second aspect or its various implementations.

In a fifth aspect, a terminal device is provided, and includes a processor and a memory. The memory is configured to store a computer program, and the processor is configured to invoke and execute the computer program stored in the memory, to perform the method in the above first aspect or its various implementations.

In a sixth aspect, a network device is provided, and includes a processor and a memory; the memory is configured to store a computer program, and the processor is configured to invoke and execute the computer program stored in the memory, to perform the method in the above second aspect or its various implementations.

In a seventh aspect, a chip is provided for implementing the method of any one of the above first aspect to the above second aspect or their various implementations.

In some embodiments, the chip includes: a processor, configured to invoke and execute a computer program from a memory, to cause a device equipped with the apparatus to perform the method of any one of the above first aspect to the above second aspect or their various implementations.

In an eighth aspect, a non-transitory computer readable storage medium is provided, for storing a computer program, and the computer program causes a computer to perform the method of any one of the above first aspect to the above second aspect or their various implementations.

In a ninth aspect, a computer program product is provided, and includes computer program instructions, and the computer program instructions cause a computer to perform the method of any one of the above first aspect to the above second aspect or their various implementations.

In a tenth aspect, a computer program is provided, and the computer program, when being executed on a computer, causes the computer to perform the method of any one of the above first aspect to the above second aspect or their various implementations.

### BRIEF DESCRIPTION OF THE DRAWINGS

FIG. 1 is a schematic diagram of a communication system architecture, provided by the embodiments of the present application.

FIG. 2 is a schematic diagram of DMRS patterns under a DMRS type 1 and a DMRS type 2.

FIG. 3 is a schematic interaction diagram of a wireless communication method, provided according to the embodiments of the present application.

FIG. 4 is a schematic diagram of a multi-panel simultaneous transmission scheme, provided by the embodiments of the present application.

FIG. 5 is a schematic diagram of another multi-panel simultaneous transmission scheme, provided by the embodiments of the present application.

FIG. 6 is a schematic block diagram of a terminal device, provided according to the embodiments of the present application.

FIG. 7 is a schematic block diagram of a network device, provided according to the embodiments of the present application.

FIG. 8 is a schematic block diagram of a communication device, provided according to the embodiments of the present application.

FIG. 9 is a schematic block diagram of a chip, provided according to the embodiments of the present application.

FIG. 10 is a schematic block diagram of a communication system, provided according to the embodiments of the present application.

### DETAILED DESCRIPTION

The technical solutions in the embodiments of the present application will be described in conjunction with the drawings in the embodiments of the present application, and apparently, the described embodiments are a part of the embodiments of the present application, but not all of the embodiments. For the embodiments of the present application, all other embodiments obtained by the ordinary skilled in the art belong to the protection scope of the present application.

The technical solutions of the embodiments of the present application may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Network (WLAN), a Wireless Fidelity (WiFi), a fifth-generation communication (5th-Generation, 5G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (D2D) communication, Machine to Machine (M2M) communication, Machine Type Communication (MTC), Vehicle to Vehicle (V2V) communication, or Vehicle to everything (V2X) communication, etc., and the embodiments of the present application may also be applied to these communication systems.

Optionally, the communication system in the embodiments of the present application may be applied to a carrier aggregation (CA) scenario, may also be applied to a dual connectivity (DC) scenario, and may also be applied to a standalone (SA) network deployment scenario.

Optionally, the communication system in the embodiments of the present application may be applied to an unlicensed spectrum, where the unlicensed spectrum may also be considered as a shared spectrum; or the communication system in the embodiments of the present application may also be applied to a licensed spectrum, where the licensed spectrum may also be considered as an unshared spectrum.

The embodiments of the present application describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (WLL) station, or a personal digital assistant (PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the present application, the terminal device may be deployed on land, which includes indoor or outdoor, in handheld, worn or vehicle-mounted; may also be deployed on water (e.g., on a ship); may also be deployed in the air (e.g., on an airplane, a balloon, a satellite).

In the embodiments of the present application, the terminal device may be a mobile phone, a pad, a computer with a wireless transceiver function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, etc.

As an example but not a limitation, in the embodiments of the present application, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the application, the network device may be a device used for communicating with a mobile device. The network device may be an Access Point (AP) in the WLAN, a base station (Base Transceiver Station, BTS) in the GSM or CDMA, may also be a base station (NodeB, NB) in the WCDMA, or may also be an evolutionary base station (Evolutionary Node B, cNB or eNodeB) in the LTE, or a relay station or an access point, or a vehicle-mounted device, a wearable device, and a network device (gNB) in an NR network, or a network device in the PLMN network evolved in the future or a network device in the NTN network, etc.

As an example but not a limitation, in the embodiments of the present application, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station provided on land, water, and other places.

In the embodiments of the present application, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc., these small cells have characteristics of small coverage range and low transmission power, which are applicable for providing a data transmission service with high speed.

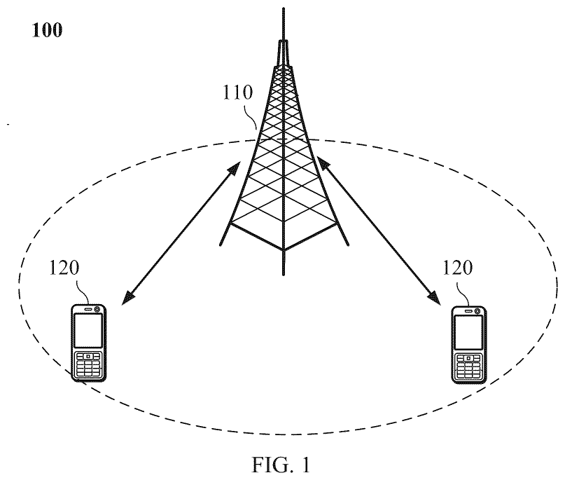

Exemplarily, the communication system 100 applied by the embodiments of the present application is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area and may communicate with a terminal device located within the coverage area.

FIG. 1 exemplarily shows one network device and two terminal devices, and optionally, the communication system 100 may include a plurality of network devices and may include another number of terminal devices within a coverage range of each network device, the embodiments of the present application are not limited thereto.

Optionally, the communication system 100 may also include other network entities such as a network controller and a mobility management entity, which are not limited to the embodiments of the present application.

It should be understood that, in the embodiments of the present application, a device with a communication function in the network/system may be referred to as a communication device. Taking the communication system 100 shown in FIG. 1 as an example, the communication device may include the network device 110 and the terminal device 120 with the communication function, and the network device 110 and the terminal device 120 may be the devices described above, which will not be repeated herein; the communication device may also include other devices in the communication system 100, such as a network controller, a mobility management entity, and other network entities, which are not limited in the embodiments of the present application.

It should be understood that the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that the “indication” mentioned in the embodiments of the present application may be a direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present application, the term “correspondence” may mean that there is a direct correspondence or indirect correspondence between the two, it may also mean that there is an associated relationship between the two, or it may also mean a relationship of indicating and being indicated or a relationship of configuring and being configured, etc.

In the embodiments of the present application, the “predefined” may be implemented by pre-saving corresponding codes, tables or other manners that may be used to indicate related information, in the device (for example, including the terminal device and the network device), and the present application does not limit its implementation. For example, the predefined may refer to what is defined in a protocol.

In the embodiments of the present application, the “protocol” may refer to standard protocols in the communication field, for example, may include an LTE protocol, an NR protocol, and related protocols applied in future communication systems, which are not limited to the present application.

To facilitate the understanding of the technical solutions of the embodiments of the present application, relevant terms of the present application are explained.

Antenna port: is referred to as a port, for short. The antenna port has a logical meaning. One antenna port may correspond to one physical transmission antenna, or a plurality of physical transmission antennas. One antenna port may be configured for each virtual antenna, each virtual antenna may be a weighted combination of a plurality of physical antennas, and each antenna port may correspond to one reference signal port. The antenna port is used to carry at least one of a specific physical channel or physical signal. Signals transmitted by a same antenna port, regardless of whether these signals are transmitted by a same physical antenna or different physical antennas, channels corresponding to paths they pass through in the spatial transmission may be considered to be the same or related (for example, large-scale channel characteristics, such as a channel matrix H, is the same). That is, for signals transmitted by a same antenna port, a receiver may consider that their channels are the same or related, during demodulation. That is, the antenna port defines a channel on a certain symbol.

The terminal device performs channel estimation and data demodulation according to a reference signal corresponding to one antenna port. For example, the terminal device performs the channel estimation and the data demodulation according to a demodulation reference signal (DMRS) corresponding to a DMRS port.

In the embodiments of the present application, an antenna port used to transmit the DMRS is referred to as a port of the DMRS, or a DMRS port, and an antenna port used to transmit a phase tracking reference signal (Phase Tracking Reference Signal, PT-RS) is referred to as a port of the PT-RS or a PT-RS port.

DMRS pattern: is a distribution pattern of time-frequency resources allocated to different mapping of Code Division Multiplexing (CDM) antenna port groups/DMRS ports for the DMRS transmission, presented in time-frequency resources. The DMRS pattern may include a DMRS type 1 (type 1) and a DMRS type 2 (type 2), where each type includes cases where a maximum number of symbols is 1 and 2, that is, resources used to transmit the DMRS occupy one symbol or two symbols.

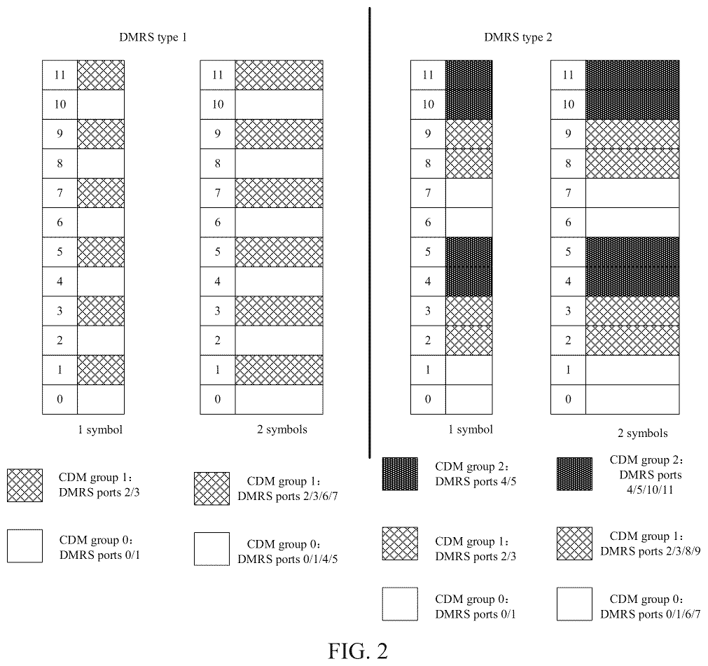

FIG. 2 shows a schematic diagram of a DMRS pattern and a corresponding DMRS port mapping, where vertical numbers 0 to 11 indicate 12 subcarriers occupied in frequency domain, and horizontal 1 symbol or 2 symbols indicate a number of symbols occupied in time domain. The case of 1 symbol under the DRMS type 1 is taken as an example for illustration purposes, it can be seen from FIG. 2 that the DMRS pattern with 1 symbol under the DRMS type corresponds to two CDM groups (which are also referred to as DMRS CDM groups), i.e., a CDM group 0 and a CDM group 1, respectively. The CDM group 0 includes a DMRS port 0 and a DMRS port 1, and the CDM group 1 includes a DMRS port 2 and a DMRS port 3. In the figure, “0/1” and “2/3” are DMRS port indexes.

Transmission layer (which is also referred to as a layer): the concept of the transmission layer is described from the perspective of a process of data processing of a physical layer, and data transmitted from a medium access control (MAC) layer to the physical layer is organized in a form of transport blocks (TB). The MAC layer may transmit one TB or a plurality of TBs to the physical layer. A transmitter performs pre-processing, scrambling, modulation, layer mapping, precoding, and time-frequency resource mapping on each TB, and converts the signal after the time-frequency resource mapping into a time-domain signal and transmits it out. Here, a TB, after the pre-processing, may be referred to as a codeword (code word, CW), and the codeword may be regarded as a TB with error protection. The pre-processing includes at least channel coding (turbo coder) and rate matching. The codeword is scrambled and modulated to obtain a constellation symbol. After the layer mapping is performed on the constellation symbol, the constellation symbol is mapped to one or more transmission layers, and each transmission layer corresponds to one valid data stream. The data stream of each layer is precoded to obtain a precoded data stream. The precoding is a process of mapping a layer to an antenna port by using a precoding matrix. The precoded data stream is mapped to a time-frequency resource, and then the precoded data stream that has been mapped to the time-frequency resource is converted into a time domain signal to be transmitted out.

In some scenarios, the network device may indicate a DMRS port to the UE by an antenna port field. In some embodiments, the terminal device may determine the DMRS port in a corresponding table according to whether transmission precoding is enabled, a DMRS type, a maximum number of DMRS symbols, and a number of transmission layers of a physical uplink shared channel (PUSCH).

For example, as shown in FIG. 2, for the DMRS type 1, when the number of DMRS symbols is 1, a maximum of 4 DMRS ports are supported. When the number of DMRS symbols is 2, a maximum of 8 DMRS ports (DMRS port 0 to DMRS port 7) are supported, where DMRS ports 0, 1, 4, and 5 belong to the CDM group 0, and DMRS ports 2, 3, 6, and 7 belong to the CDM group 1.

For example, as shown in FIG. 2, for the DMRS type 2, when the number of DMRS symbols is 1, a maximum of 6 DMRS ports can be supported. When the number of DMRS symbols is 2, a maximum of 12 DMRS ports (DMRS port 0 to DMRS port 11) can be supported, where DMRS ports 0, 1, 6, and 7 belong to the CDM group 0, DMRS ports 2, 3, 8, and 9 belong to the CDM group 1, and DMRS ports 4, 5, 10, and 11 belong to the CDM group 2.

In some scenarios, the network device may transmit a Physical Downlink Shared Channel (PDSCH) to the UE by a plurality of Transmission Reception Points (TRPs) (e.g., TRP1 and TRP2) by spatial division multiplexing (SDM), where different transmission layers of the PDSCH are transmitted by different TRPs. In this case, a DMRS port of the PDSCH transmitted by TRP1 and a DMRS port of the PDSCH transmitted by TRP2 correspond to different DMRS CDM groups, respectively.

In some other scenarios, the network device may transmit a PDSCH to the UE by multi-TRPs by frequency-division multiplexing (FDM), where the PDSCH transmitted by different TRPs may use the same DMRS port.

To facilitate the understanding of the technical solutions of the embodiments of the present application, a phase tracking reference signal (PT-RS) is explained.

A number of PT-RS ports is related to a number of phase noise sources. When there is a plurality of independent phase noise sources, each phase noise source requires one PT-RS port for phase estimation.

For the PT-RS of the PUSCH, one or two PT-RS ports may be configured. For example, the number of PT-RS ports may be configured by a Radio Resource Control (RRC) signaling.

To facilitate the understanding of the embodiments of the present application, a PUSCH transmission scheme of multiple transmission reception points (TRP) or antenna panels is explained.

In an NR system, a non-coherent transmission of downlink and uplink based on multiple TRPs is introduced. Herein, a backhaul connection between TRPs may be ideal or non-ideal. In an ideal backhaul, TRPs may exchange information quickly and dynamically. In a non-ideal backhaul, TRPs may only exchange information quasi-statically due to a large latency. In a downlink non-coherent transmission, a plurality of TRPs may use different control channels to independently schedule a plurality of PUSCH transmissions of a terminal device, or use a same control channel to schedule transmissions of different TRPs, where data of different TRPs uses different transmission layers. The latter case can only be used in the ideal backhaul condition.

In some cases, the UE may transmit the PUSCH to two TRPs in a time-division multiplexing (TDM) manner, which is referred to as a TDM transmission scheme.

To facilitate the understanding of the embodiments of the present application, the PUSCH TDM repetition transmission of multi-TRPs and the mapping between a PT-RS and a DMRS are explained.

In some scenarios, the PUSCH TDM repetition transmission of multi-TRPs is enhanced, where a type of the PUSCH repetition transmission includes: a PUSCH repetition type A and a PUSCH repetition type B. Since the number of transmission layers of the PUSCH repetition type A is limited to 1, there is no need to additionally indicate the mapping between a PT-RS port and a DMRS port. For the PUSCH repetition type B, the number of transmission layers may be greater than 1.

When a maximum number of ranks (maxrank) is equal to 2 (that is, the maximum number of transmission layers is 2), only one PT-RS port is required, and 2 bits in the DCI 0-1 or DCI 0-2 are used to indicate an association relationship between the PT-RS port and the DMRS port. As shown in Table 1, a most significant bit (MSB) and a least significant bit (LSB) of the 2 bits correspond to the TRP1 and TRP2, respectively. The state 0 of the MSB indicates that the PT-RS of the PUSCH transmitted to the TRP1 is associated with a first DMRS port; the state 1 of the MSB indicates that the PT-RS of the PUSCH transmitted to the TRP1 is associated with a second DMRS port. The state 0 of the LSB indicates that the PT-RS of the PUSCH transmitted to the TRP2 is associated with a first DMRS port; the state 1 of the LSB indicates that the PT-RS of the PUSCH transmitted to the TRP2 is associated with a second DMRS port.

TABLE 1

| MSB | | LSB | |
|---|---|---|---|
| state | | state | |
| value | DMRS port | value | DMRS port |
| 0 | A first DMRS port associated with | 0 | A first DMRS port associated with a |
| | a first SRI, first precoding | | second SRI, second precoding |
| | information, and a layer number | | information, and a layer number field |
| | field | | |
| 1 | A second DMRS port associated | 1 | A second DMRS port associated with |
| | with a first SRI, first precoding | | a second SRI, second precoding |
| | information, and a layer number | | information, and a layer number field |
| | field | | |

When the maxrank is greater than 2 (i.e., the maximum number of transmission layers is greater than 2), one or two PT-RS ports are required according to a transmit precoding matrix indicator (Transmit Precoding Matrix Indicator, TPMI) and the number of transmission layers. 4 bits in the DCI 0-1 or DCI 0-2 are used to indicate an association between a PT-RS port and a DMRS port (where a PTRS-DMRS association field and a second PTRS-DMRS association field are 2 bits, respectively). When an actual number of PT-RS ports is determined to be 1 according to the TPMI and the number of transmission layers, the DMRS port associated with the PT-RS port is determined according to Table 2. When the actual number of PT-RS ports is determined to be 2 according to the TPMI and the number of transmission layers, the DMRS port associated with the PT-RS port is determined according to Table 3, where the MSB and LSB in Table 3 are associated with different TRPs, respectively, and then the DMRS port associated with the PT-RS is determined by the states of the MSB and LSB.

TABLE 2

| State | |
|---|---|
| value | DMRS port |
| 0 | First DMRS port |
| 1 | Second DMRS port |
| 2 | Third DMRS port |
| 3 | Fourth DMRS port |

TABLE 3

| MSB | | LSB | |
|---|---|---|---|
| state | | state | |
| value | DMRS port | value | DMRS port |
| 0 | First DMRS port sharing | 0 | First DMRS port sharing |
| | the PT-RS port 0 | | the PT-RS port 1 |
| 1 | Second DMRS port sharing | 1 | Second DMRS port sharing |
| | the PT-RS port 0 | | the PT-RS port 1 |

To facilitate the understanding of the technical solutions of the embodiments of the present application, a codebook-based PUSCH transmission scheme is explained.

Step 1: the terminal device transmits a sounding reference signal (SRS) for a codebook to the network device;

Step 2: the network device performs uplink channel detection according to the SRS transmitted by the terminal device, performs resource scheduling for the terminal device, and determines an SRS resource corresponding to a PUSCH transmission, the number of layers and a precoding matrix for the PUSCH transmission; the network device indicates the above information to the terminal device by downlink control information (DCI);

Step 3: the terminal device receives the DCI and transmits the PUSCH according to an indication of the DCI.

In the codebook-based PUSCH transmission scheme, the network device indicates the SRS resource corresponding to the PUSCH, the number of transmission layers of the PUSCH, and the precoding matrix of the PUSCH, to the terminal device by the DCI. Fields in the DCI include a Precoding information and number of layers field (used to indicate the precoding matrix and the number of transmission layers) and an SRS resource indicator (SRI) field, the SRS resource indicator field is used to indicate a specific SRS resource in an SRS resource set.

In some cases, the number of transmission layers of the PUSCH and the precoding matrix of the PUSCH are indicated in a joint encoding manner.

To facilitate the understanding of the technical solutions of the embodiments of the present application, a non-codebook-based PUSCH transmission scheme is explained.

Step 1: the UE measures a downlink reference signal, obtains a candidate precoding matrix, precodes an SRS by using the candidate precoding matrix, and then transmits the SRS for a non-codebook to the network device.

Step 2: the network device performs uplink channel detection according to the SRS transmitted by the terminal device, performs resource scheduling for the UE, and determines an SRS resource corresponding to a beam for a PUSCH transmission; the network device indicates the above information to the terminal device by DCI.

Step 3: the terminal device receives the DCI and transmits the PUSCH according to an indication of the DCI.

In the non-codebook-based PUSCH transmission scheme, the network device indicates the number of transmission layers of the PUSCH and the specific SRS resource in an SRS resource set to the terminal device by an SRI field in the DCI.

In summary, the number of transmission layers of the codebook-based PUSCH is indicated by the “Precoding information and number of layers” field, and the number of transmission layers of the non-codebook-based PUSCH is indicated by the “SRS resource indicator” field. The DMRS port is indicated by the “antenna port(s)” field, where the number of DMRS ports is determined according to the number of transmission layers, and different numbers of transmission layers correspond to different tables. In a scenario of the multi-panel simultaneous transmission of the UE, the DMRS port or port group of the PUSCH transmitted by each panel may be the same or different, and the number of transmission layers of the PUSCH transmitted by each panel may be the same or different. Therefore, how to determine the DMRS port and the number of transmission layers of the PUSCH transmitted by each panel in the multi-panel transmission, is a problem that needs to be solved. Furthermore, in a scenario of the multi-panel simultaneous transmission, how to determine the number of PT-RS ports and the associated DMRS ports of the PUSCH transmitted by each panel is also a problem that needs to be solved.

In order to facilitate the understanding of the technical solutions of the embodiments of the present application, the technical solutions of the present application are described in detail below through some embodiments. The above-related technologies, as optional solutions, may be randomly combined with the technical solutions of the embodiments of the present application, which all belong to the protection scope of the embodiments of the present application. The embodiments of the present application include at least some of the following contents.

In the embodiments, a wireless communication method is provided, the method is applied to a terminal device and includes:
determining port information of a demodulation reference signal (DMRS) and/or transmission layer number information of a plurality of uplink information according to target antenna port indication information, where the plurality of uplink information is associated with different spatial parameters, and the plurality of uplink information includes first uplink information and second uplink information.

In some embodiments, the target antenna port indication information includes first antenna port indication information and second antenna port indication information;
the determining the port information of the demodulation reference signal (DMRS) and/or the transmission layer number information of the plurality of uplink information according to the target antenna port indication information, includes:
determining port information of a first DMRS according to the first antenna port indication information and determining port information of a second DMRS according to the second antenna port indication information;
where the first DMRS is associated with the first uplink information, and the second DMRS is associated with the second uplink information.

In some embodiments, the determining the port information of the first DMRS according to the first antenna port indication information and determining the port information of the second DMRS according to the second antenna port indication information, includes:
determining the port information of the first DMRS according to the first antenna port indication information and a first transmission parameter, and determining the port information of the second DMRS according to the second antenna port indication information and a second transmission parameter;
where the first transmission parameter is associated with the first uplink information, and the second transmission parameter is associated with the second uplink information.

In some embodiments, the first transmission parameter includes at least one of:
a first number of layers, a type of the first DMRS, a maximum number of symbols of the first DMRS, or a number of DMRS code division multiplexing (CDM) groups;
the second transmission parameter includes at least one of:
a second number of layers, a type of the second DMRS, a maximum number of symbols of the second DMRS, or a number of DMRS CDM groups.

In some embodiments, the determining the port information of the first DMRS according to the first antenna port indication information and the first transmission parameter, includes:
determining a first correspondence in a plurality of correspondences according to the first number of layers, where the plurality of correspondences correspond to different numbers of transmission layers, respectively, the first correspondence corresponds to the first number of layers, and the first correspondence includes a correspondence between a state value of antenna port indication information and port information of a DMRS;
determining the port information of the first DMRS according to the first antenna port indication information and the first correspondence.

In some embodiments, in a case where the first number of layers is 3, the type of the first DMRS is a type 1, and the maximum number of symbols of the first DMRS is 2, in the first correspondence, the state value of the antenna port indication information is used to indicate at least one of following DMRS ports:
DMRS ports 0, 1, 4; or
DMRS ports 2, 3, 6.

In some embodiments, in a case where the first number of layers is 3, the type of the first DMRS is a type 2, and the maximum number of symbols of the first DMRS is 2, in the first correspondence, the state value of the antenna port indication information is used to indicate at least one of following DMRS ports:
DMRS ports 0, 1, 6;
DMRS ports 2, 3, 8; or
DMRS ports 4, 5, 10.

In some embodiments, the determining the port information of the second DMRS according to the second antenna port indication information and the second transmission parameter, includes:
determining a second correspondence in a plurality of correspondences according to the second number of layers, where the plurality of correspondences correspond to different numbers of transmission layers, respectively, the second correspondence corresponds to the second number of layers, and the second correspondence includes a correspondence between a state value of antenna port indication information and port information of a DMRS;
determining the port information of the second DMRS according to the second antenna port indication information and the second correspondence.

In some embodiments, in a case where the second number of layers is 3, the type of the second DMRS is a type 1, and the maximum number of symbols of the second DMRS is 2, in the second correspondence, the state value of the antenna port indication information is used to indicate at least one of following DMRS ports:
DMRS ports 0, 1, 4; or DMRS ports 2, 3, 6.

In some embodiments, in a case where the second number of layers is 3, the type of the second DMRS is a type 2, and the maximum number of symbols of the second DMRS is 2, in the second correspondence, the state value of the antenna port indication information is used to indicate at least one of following DMRS ports:
DMRS ports 0, 1, 6;
DMRS ports 2, 3, 8; or
DMRS ports 4, 5, 10.

In some embodiments, a port of the first DMRS and a port of the second DMRS are in different DMRS CDM groups, where the first DMRS is associated with the first uplink information, and the second DMRS is associated with the second uplink information.

In some embodiments, the first transmission parameter is configured or indicated by a network device, and the second transmission parameter is configured or indicated by a network device.

In some embodiments, the target antenna port indication information includes third antenna port indication information, and the determining the port information of the demodulation reference signal (DMRS) and/or the transmission layer number information of the plurality of uplink information according to the target antenna port indication information, includes:
determining port information of a first DMRS, port information of a second DMRS, a first number of layers, and a second number of layers according to the third antenna port indication information;
where the first DMRS and the first number of layers are associated with the first uplink information, and the second DMRS and the second number of layers are associated with the second uplink information.

In some embodiments, the determining the port information of the first DMRS, the port information of the second DMRS, the first number of layers, and the second number of layers according to the third antenna port indication information, includes:
determining the port information of the first DMRS, the port information of the second DMRS, the first number of layers, and the second number of layers according to the third antenna port indication information and a third transmission parameter;
where the third transmission parameter includes a transmission parameter of the first uplink information and a transmission parameter of the second uplink information.

In some embodiments, the third transmission parameter includes at least one of:
a type of the first DMRS, a maximum number of symbols of the first DMRS, a type of the second DMRS, a maximum number of symbols of the second DMRS, or a number of DMRS CDM groups;
where the type of the first DMRS and the maximum number of symbols of the first DMRS are associated with the first uplink information, and the type of the second DMRS and the maximum number of symbols of the second DMRS are associated with the second uplink information.

In some embodiments, the third antenna port indication information is used to indicate at least one of following states:
the port information of the first DMRS, the port information of the second DMRS, a port of the first DMRS and a port of the second DMRS being in different CDM groups, and a first layer number combination: the first number of layers and the second number of layers being both 1;
the port information of the first DMRS, the port information of the second DMRS, the port of the first DMRS and the port of the second DMRS being in different CDM groups, and a second layer number combination: the first number of layers being 2 and the second number of layers being 1;
the port information of the first DMRS, the port information of the second DMRS, the port of the first DMRS and the port of the second DMRS being in different CDM groups, and a third layer number combination: the first number of layers being 1 and the second number of layers being 2;
the port information of the first DMRS, the port information of the second DMRS, the port of the first DMRS and the port of the second DMRS being in different CDM groups, and a fourth layer number combination: the first number of layers being 2 and the second number of layers being 2;
the port information of the first DMRS, the port information of the second DMRS, the port of the first DMRS and the port of the second DMRS being in different CDM groups, and a fifth layer number combination: the first number of layers being 1 and the second number of layers being 3; or
the port information of the first DMRS, the port information of the second DMRS, the port of the first DMRS and the port of the second DMRS being in different CDM groups, and a sixth layer number combination: the first number of layers being 3 and the second number of layers being 1.

In some embodiments, the target antenna port indication information includes fourth antenna port indication information, and the determining the port information of the demodulation reference signal (DMRS) and/or the transmission layer number information of the plurality of uplink information according to the target antenna port indication information, includes:
determining port information of a first DMRS and port information of a second DMRS according to the fourth antenna port indication information;
where the first DMRS is associated with the first uplink information, and the second DMRS is associated with the second uplink information.

In some embodiments, the determining the port information of the first DMRS and the port information of the second DMRS according to the fourth antenna port indication information, includes:
determining the port information of the first DMRS and the port information of the second DMRS according to the fourth antenna port indication information and a fourth transmission parameter;
where the fourth transmission parameter includes a transmission parameter of the first uplink information and a transmission parameter of the second uplink information.

In some embodiments, the fourth transmission parameter includes at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
where the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.

In some embodiments, a port of the first DMRS and a port of the second DMRS are in different DMRS CDM groups, where the first DMRS is associated with the first uplink information, and the second DMRS is associated with the second uplink information.

In some embodiments, the determining the port information of the first DMRS and the port information of the second DMRS according to the fourth antenna port indication information and the fourth transmission parameter, includes:
determining a third correspondence in a plurality of correspondences according to a sum of a first number of layers and a second number of layers, where the plurality of correspondences correspond to different numbers of transmission layers, respectively, the third correspondence corresponds to the sum of the first number of layers and the second number of layers, and the third correspondence includes a correspondence between a state value of antenna port indication information, and port information of the first DMRS and port information of the second DMRS;
determining the port information of the first DMRS and the port information of the second DMRS according to the fourth antenna port indication information and the third correspondence.

In some embodiments, the first DMRS and the second DMRS are located on different symbols in time domain, where the first DMRS is associated with the first uplink information, and the second DMRS is associated with the second uplink information.

In some embodiments, the plurality of uplink information is transmitted by using a spatial division multiplexing (SDM) transmission scheme.

In some embodiments, the first uplink information is associated with a first spatial parameter, and the second uplink information is associated with a second spatial parameter, where the first uplink information and the second uplink information are different transmission layers of target uplink information, and a transmission layer associated with the first spatial parameter and a transmission layer associated with the second spatial parameter are mapped to different codewords.

In some embodiments, the target antenna port indication information includes fifth antenna port indication information, and the determining the port information of the demodulation reference signal (DMRS) and/or the transmission layer number information of the plurality of uplink information according to the target antenna port indication information, includes:
determining port information of a first DMRS and port information of a second DMRS according to the fifth antenna port indication information;
where the first DMRS is associated with the first uplink information, and the second DMRS is associated with the second uplink information.

In some embodiments, the determining the port information of the first DMRS and the port information of the second DMRS according to the fifth antenna port indication information, includes:
determining the port information of the first DMRS and the port information of the second DMRS according to the fifth antenna port indication information and a target number of layers, where the target number of layers is a larger number of layers among a first number of layers and a second number of layers, the first number of layers is associated with the first uplink information, and the second number of layers is associated with the second uplink information.

In some embodiments, the determining the port information of the first DMRS and the port information of the second DMRS according to the fifth antenna port indication information and the target number of layers includes:
determining a fourth correspondence in a plurality of correspondences according to the target number of layers, where the plurality of correspondences correspond to different numbers of transmission layers, respectively, the fourth correspondence corresponds to the target number of layers, and the fourth correspondence includes a correspondence between a state value of antenna port indication information and port information of a DMRS; and
determining the port information of the first DMRS and the port information of the second DMRS according to the fifth antenna port indication information and the fourth correspondence.

In some embodiments, the fourth correspondence includes port information of a DMRS corresponding to the target number of layers, where the determining the port information of the first DMRS and the port information of the second DMRS according to the fifth antenna port indication information and the fourth correspondence, includes:
determining the port information of the DMRS corresponding to the target number of layers, in the fourth correspondence according to a state value of the fifth antenna port indication information;
if the target number of layers is the first number of layers, determining the port information of the DMRS corresponding to the target number of layers as the port information of the first DMRS, and determining a subset of the port information of the DMRS corresponding to the target number of layers as the port information of the second DMRS; or
if the target number of layers is the second number of layers, determining the port information of the DMRS corresponding to the target number of layers as the port information of the second DMRS, and determining a subset of the port information of the DMRS corresponding to the target number of layers as the port information of the first DMRS.

In some embodiments, the fourth correspondence includes port information of a DMRS corresponding to the target number of layers, and port information of a DMRS corresponding to a smaller number of layers among the first number of layers and the second number of layers;
where the determining the port information of the first DMRS and the port information of the second DMRS according to the fifth antenna port indication information and the fourth correspondence, includes:
determining the port information of the DMRS corresponding to the target number of layers and the port information of the DMRS corresponding to the smaller number of layers among the first number of layers and the second number of layers, in the fourth correspondence according to a state value of the fifth antenna port indication information;
if the target number of layers is the first number of layers, determining the port information of the DMRS corresponding to the target number of layers as the port information of the first DMRS, and determining the port information of the DMRS corresponding to the smaller number of layers as the port information of the second DMRS; or
if the target number of layers is the second number of layers, determining the port information of the DMRS corresponding to the target number of layers as the port information of the second DMRS, and determining the port information of the DMRS corresponding to the smaller number of layers as the port information of the first DMRS.

In some embodiments, in the fourth correspondence, the port information of the DMRS corresponding to the smaller number of layers is a subset of the port information of the DMRS corresponding to the target number of layers.

In some embodiments, the port information of the DMRS corresponding to the smaller number of layers is indicated by a codepoint in the fifth antenna port indication information.

In some embodiments, if the first number of layers is the same as the second number of layers, the port information of the first DMRS is the same as the port information of the second DMRS; or if the first number of layers is different from the second number of layers, port information of a DMRS corresponding to a smaller number of layers among the first number of layers and the second number of layers is a subset of port information of a DMRS corresponding to a larger number of layers among the first number of layers and the second number of layers.

In some embodiments, the port information of the DMRS corresponding to the smaller number of layers among the first number of layers and the second number of layers being the subset of the port information of the DMRS corresponding to the larger number of layers, includes that:
ports of the DMRS corresponding to the smaller number of layers include first n ports of the DMRS with smallest port indices among ports of the DMRS corresponding to the larger number of layers, where n is the smaller number of layers.

In some embodiments, the plurality of uplink information is transmitted by using a frequency division multiplexing (FDM) transmission scheme or single frequency network (SFN) transmission scheme.

In some embodiments, the target antenna port indication information is configured by downlink control information (DCI).

In some embodiments, the method further includes:
determining DMRS ports associated with PT-RS ports corresponding to the plurality of uplink information according to a number of the PT-RS ports corresponding to the plurality of uplink information and port association indication information, where the port association indication information is used to indicate an association relationship between the PT-RS ports and the DMRS ports.

In some embodiments, the number of the PT-RS ports used to transmit the plurality of uplink information is determined according to first information, and the first information includes at least one of:
a number of spatial parameters associated with the plurality of uplink information;
a transmission mode used for simultaneously transmitting the plurality of uplink information;
a number of DMRS CDM groups corresponding to the port information of the DMRS of the plurality of uplink information;
a number of transmission layers of the plurality of uplink information;
a precoding matrix of the plurality of uplink information; or
a maximum number of PT-RS ports corresponding to the plurality of uplink information.

In some embodiments, if the number of the PT-RS ports corresponding to the plurality of uplink information is 2, including a PT-RS port 0 and a PT-RS port 1, a number of transmission layers of the first uplink information and the second uplink information does not exceed 2, a state value of the port association indication information is used to indicate DMRS ports associated with the PT-RS port 0 and the PT-RS port 1, respectively, and the DMRS ports associated with the PT-RS port 0 and the PT-RS port 1 is determined according to the port association indication information and a first association relationship;
in the first association relationship, the PT-RS port 0 is associated with a first target DMRS port or a second target DMRS port, where the first target DMRS port is a first DMRS port associated with a first spatial parameter, the second target DMRS port is a second DMRS port associated with the first spatial parameter, and the first spatial parameter is associated with the first uplink information;
in the first association relationship, the PT-RS port 1 is associated with a third target DMRS port or a fourth target DMRS port, where the third target DMRS port is a first DMRS port associated with a second spatial parameter, the fourth target DMRS port is a second DMRS port associated with the second spatial parameter, and the second spatial parameter is associated with the second uplink information.

In some embodiments, if the number of the PT-RS ports corresponding to the plurality of uplink information is 2, a number of transmission layers of the first uplink information or the second uplink information is 3, a state value of the port association indication information is used to indicate a DMRS port associated with a first PT-RS port respectively, and the first PT-RS port is a PT-RS port of the uplink information with the number of transmission layers equal to 3 among the first uplink information and the second uplink information, where the DMRS port associated with the first PT-RS port is determined according to the port association indication information and a second association relationship;

in the second association relationship, different state values of the port association indication information are used to indicate a target DMRS port associated with the first PT-RS port, where the target DMRS port is associated with a target spatial parameter, and the target spatial parameter is associated with the uplink information with the number of transmission layers equal to 3 among the first uplink information and the second uplink information.

In some embodiments, the state value of the port association indication information is used to indicate at least one of following DMRS ports:
a first DMRS port associated with the target spatial parameter;
a second DMRS port associated with the target spatial parameter;
a third DMRS port associated with the target spatial parameter; or
a fourth DMRS port associated with the target spatial parameter.

In some embodiments, the plurality of uplink information is transmitted by using an SDM transmission scheme, an FDM transmission scheme or an SFN transmission scheme.

In some embodiments, each uplink information of the plurality of uplink information is associated with at least one transmission layer of target uplink information, and the terminal device expects that a DMRS port associated with a PT-RS port corresponding to the plurality of uplink information is used to transmit a transmission layer with a best quality in the target uplink information.

In some embodiments, the plurality of uplink information is transmitted by using an FDM transmission scheme or an SFN transmission scheme.

In the embodiments, a wireless communication method is provided, the method is applied to a network device and includes:
transmitting target antenna port indication information to a terminal device, where the target antenna port indication information is used by the terminal device to determine port information of a demodulation reference signal (DMRS) and/or transmission layer number information of a plurality of uplink information, the plurality of uplink information is associated with different spatial parameters, and the plurality of uplink information includes first uplink information and second uplink information.

In some embodiments, the method further includes:
determining the port information of the DMRS and/or the transmission layer number information of the plurality of uplink information.

In some embodiments, the target antenna port indication information includes first antenna port indication information and second antenna port indication information, the first antenna port indication information is used to determine port information of a first DMRS, and the second antenna port indication information is used to determine port information of a second DMRS; where the first DMRS is associated with the first uplink information, and the second DMRS is associated with the second uplink information.

In some embodiments, the port information of the first DMRS is determined according to the first antenna port indication information and a first transmission parameter, and the port information of the second DMRS is determined according to the second antenna port indication information and a second transmission parameter, where the first transmission parameter is associated with the first uplink information, and the second transmission parameter is associated with the second uplink information.

In some embodiments, the first transmission parameter includes at least one of:
a first number of layers, a type of the first DMRS, a maximum number of symbols of the first DMRS, or a number of DMRS code division multiplexing (CDM) groups;
the second transmission parameter includes at least one of:
a second number of layers, a type of the second DMRS, a maximum number of symbols of the second DMRS, or a number of DMRS CDM groups.

In some embodiments, a port of the first DMRS and a port of the second DMRS are in different DMRS CDM groups, where the first DMRS is associated with the first uplink information, and the second DMRS is associated with the second uplink information.

In some embodiments, the target antenna port indication information includes third antenna port indication information, and the third antenna port indication information is used to determine port information of a first DMRS, port information of a second DMRS, a first number of layers, and a second number of layers;
where the first DMRS and the first number of layers are associated with the first uplink information, and the second DMRS and the second number of layers are associated with the second uplink information.

In some embodiments, the port information of the first DMRS, the port information of the second DMRS, the first number of layers and the second number of layers are determined according to the third antenna port indication information and a third transmission parameter, where the third transmission parameter includes a transmission parameter of the first uplink information and a transmission parameter of the second uplink information.

In some embodiments, the third transmission parameter includes at least one of:
a type of the first DMRS, a maximum number of symbols of the first DMRS, a type of the second DMRS, a maximum number of symbols of the second DMRS, or a number of DMRS CDM groups;
where the type of the first DMRS and the maximum number of symbols of the first DMRS are associated with the first uplink information, and the type of the second DMRS and the maximum number of symbols of the second DMRS are associated with the second uplink information.

In some embodiments, the third antenna port indication information is used to indicate at least one of following states:
the port information of the first DMRS, the port information of the second DMRS, a port of the first DMRS and a port of the second DMRS being in different CDM groups, and a first layer number combination: the first number of layers and the second number of layers being both 1;
the port information of the first DMRS, the port information of the second DMRS, the port of the first DMRS and the port of the second DMRS being in different CDM groups, and a second layer number combination: the first number of layers being 2 and the second number of layers being 1;
the port information of the first DMRS, the port information of the second DMRS, the port of the first DMRS and the port of the second DMRS being in different CDM groups, and a third layer number combination: the first number of layers being 1 and the second number of layers being 2;
the port information of the first DMRS, the port information of the second DMRS, the port of the first DMRS and the port of the second DMRS being in different CDM groups, and a fourth layer number combination: the first number of layers being 2 and the second number of layers being 2;
the port information of the first DMRS, the port information of the second DMRS, the port of the first DMRS and the port of the second DMRS being in different CDM groups, and a fifth layer number combination: the first number of layers being 1 and the second number of layers being 3; or
the port information of the first DMRS, the port information of the second DMRS, the port of the first DMRS and the port of the second DMRS being in different CDM groups, and a sixth layer number combination: the first number of layers being 3 and the second number of layers being 1.

In some embodiments, the target antenna port indication information includes fourth antenna port indication information, and the fourth antenna port indication information is used to determine port information of a first DMRS and port information of a second DMRS, where the first DMRS is associated with the first uplink information, and the second DMRS is associated with the second uplink information.

In some embodiments, the port information of the first DMRS and the port information of the second DMRS are determined according to the fourth antenna port indication information and a fourth transmission parameter, where the fourth transmission parameter includes a transmission parameter of the first uplink information and a transmission parameter of the second uplink information.

In some embodiments, the fourth transmission parameter includes at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
where the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.

In some embodiments, a port of the first DMRS and a port of the second DMRS are in different DMRS CDM groups, where the first DMRS is associated with the first uplink information, and the second DMRS is associated with the second uplink information.

In some embodiments, the first DMRS and the second DMRS are located on different symbols in time domain, where the first DMRS is associated with the first uplink information, and the second DMRS is associated with the second uplink information.

In some embodiments, the plurality of uplink information is transmitted by using a spatial division multiplexing (SDM) transmission scheme.

In some embodiments, the first uplink information is associated with a first spatial parameter, and the second uplink information is associated with a second spatial parameter, where the first uplink information and the second uplink information are different transmission layers of target uplink information, and a transmission layer associated with the first spatial parameter and a transmission layer associated with the second spatial parameter are mapped to different codewords.

In some embodiments, the target antenna port indication information includes fifth antenna port indication information, and the fifth antenna port indication information is used to determine port information of a first DMRS and port information of a second DMRS, where the first DMRS is associated with the first uplink information, and the second DMRS is associated with the second uplink information.

In some embodiments, layer number information corresponding to the fifth antenna port indication information is to indicate a larger number of layers among a first number of layers and a second number of layers, the first number of layers is associated with the first uplink information, and the second number of layers is associated with the second uplink information.

In some embodiments, if the first number of layers is the same as the second number of layers, the port information of the first DMRS is the same as the port information of the second DMRS; or
if the first number of layers is different from the second number of layers, port information of a DMRS corresponding to a smaller number of layers among the first number of layers and the second number of layers is a subset of port information of a DMRS corresponding to a larger number of layers among the first number of layers and the second number of layers.

In some embodiments, the port information of the DMRS corresponding to the smaller number of layers among the first number of layers and the second number of layers being the subset of the port information of the DMRS corresponding to the larger number of layers, includes that:
ports of the DMRS corresponding to the smaller number of layers include first n ports of the DMRS with smallest port indices among ports of the DMRS corresponding to the larger number of layers, where n is the smaller number of layers.

In some embodiments, port information of a DMRS corresponding to a smaller number of layers among the first number of layers and the second number of layers is indicated by a codepoint in the fifth antenna port indication information.

In some embodiments, the plurality of uplink information is transmitted by using a frequency division multiplexing (FDM) transmission scheme or a single frequency network (SFN) transmission scheme.

In some embodiments, the target antenna port indication information is configured by downlink control information (DCI).

In some embodiments, the method further includes:
determining a number of PT-RS ports corresponding to the plurality of uplink information, and DMRS ports associated with the PT-RS ports corresponding to the plurality of uplink information;
transmitting port association indication information to the terminal device, to indicate an association relationship between the PT-RS ports and the DMRS ports.

In some embodiments, the number of the PT-RS ports corresponding to the plurality of uplink information is determined according to first information, and the first information includes at least one of:
a number of spatial parameters associated with the plurality of uplink information;
a transmission mode used for simultaneously transmitting the plurality of uplink information;
a number of DMRS CDM groups corresponding to the port information of the DMRS of the plurality of uplink information;
a number of transmission layers of the plurality of uplink information;
a precoding matrix of the plurality of uplink information; or
a maximum number of PT-RS ports used to transmit the plurality of uplink information.

In some embodiments, each uplink information of the plurality of uplink information is associated with at least one transmission layer of target uplink information, and the terminal device expects that a DMRS port associated with a PT-RS port corresponding to the plurality of uplink information is used to transmit a transmission layer with a best quality of the target uplink information.

In some embodiments, the plurality of uplink information is transmitted by using an FDM transmission scheme or an SFN transmission scheme.

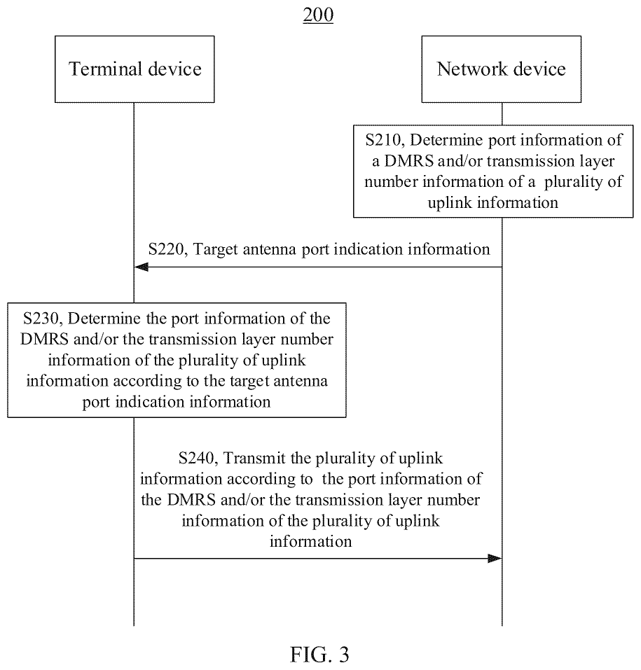

FIG. 3 is a schematic flow chart of a wireless communication method 200 according to the embodiments of the present application. The method 200 may be performed by the terminal device and the network device in the communication system shown in FIG. 1. As shown in FIG. 3, the method 200 includes the following contents.

S210, a network device determines port information of a demodulation reference signal (DMRS) and/or transmission layer number information of a plurality of uplink information.

It should be understood that the present application does not limit the specific manner in which the network device determines the port information of the DMRS and/or the transmission layer number information of the plurality of uplink information, for example, which may be determined in a measurement manner.

S220, the network device transmits target antenna port indication information to a terminal device, where the target antenna port indication information is used to determine the port information of the DMRS and/or the transmission layer number information of the plurality of uplink information.

S230, the terminal devices determines the port information of the DMRS and/or the transmission layer number information of the plurality of uplink information according to the target antenna port indication information.

Further optionally, the method 200 further includes:
S240, transmitting, by the terminal device, the plurality of uplink information according to the port information of the DMRS and/or the transmission layer number information of the plurality of uplink information.

Correspondingly, the network device receives the plurality of uplink information according to the port information of the DMRS and/or the transmission layer number information of the plurality of uplink information.

It should be understood that in the embodiments of the present application, after the network device determines the port information of the DMRS and/or the transmission layer number information of the plurality of uplink information, the network device may indicate the port information of the DMRS and/or the transmission layer number information of the plurality of uplink information to the terminal device by the target antenna port indication information. Correspondingly, the terminal device may obtain the port information of the DMRS and/or the transmission layer number information of the plurality of uplink information by interpreting the target antenna port indication information, thereby enabling the network device and the terminal device to have a consistent understanding of the port information of the DMRS and/or the transmission layer number information of the plurality of uplink information, and improving the uplink transmission performance.

In some embodiments, the plurality of uplink information may be a plurality of PUSCHs, or a plurality of PUCCHs, etc., which is not limited to the present application.

In some embodiments, the plurality of uplink information is associated with different spatial parameters, and the plurality of uplink information includes first uplink information and second uplink information.

It should be understood that the spatial parameter in the embodiments of the present application may refer to a spatial setting or a spatial relation, etc., for the uplink information transmission.

In some embodiments of the present application, the spatial parameter includes but is not limited to, at least one of:
antenna panel information, TRP information, Control Resource Set (CORESET) group information, Transmission Configuration Indicator (TCI) state information, reference signal set information, reference signal information, beam information, or capability set information.

In some embodiments, the antenna panel information may include an antenna panel ID or an antenna panel index.

In some embodiments, the TRP information may include a TRP ID or a TRP index.

In some embodiments, the CORESET group information may include an ID or an index of a CORESET group.

In some embodiments, the TCI state information may include a unified TCI state or an uplink TCI state (UL TCI state), or a joint TCI state.

In some embodiments, the reference signal set information may be synchronization signal block (SSB) resource set information or channel state information reference signal (CSI-RS) resource set information or SRS resource set information.

For example, the reference signal set information may include an index of a reference signal set, such as an index of an SSB set, an index of a CSI-RS resource set, or an index of an SRS resource set.

In some embodiments, the reference signal information may include SSB resource information, CSI-RS resource information or SRS resource information. For example, the reference signal information may be an index of an SRS resource, an SSB resource, or a CSI-RS resource.

In some embodiments, the beam information may include a beam ID or a beam index.

In the embodiments of the present application, the beam may also be referred to as a spatial domain transmission filter (Spatial domain transmission filter or Spatial domain filter for transmission), or a spatial domain reception filter (Spatial domain reception filter or Spatial domain filter for reception) or a spatial reception parameter (Spatial Rx parameter).

In some embodiments, the capability set information may include one or more parameters. For example, the capability set information may be a capability set supported by the terminal device or reference signal information associated with a capability set supported by the terminal device.

In some embodiments, the capability set information includes but is not limited to, at least one of:
a maximum number of SRS ports, a maximum number of uplink transmission layers, a codebook subset type, an uplink full-power transmission mode, an SRS antenna switching capability, an SRS carrier switching capability, a number of SRS resources transmitted simultaneously, a maximum modulation mode for an uplink data transmission, a maximum modulation mode for a downlink data transmission, a number of Hybrid Automatic Repeat Request (HARQ) processes supported by the terminal device, a channel bandwidth supported by the terminal device, a number of transmission antennas supported by the terminal device, a PDSCH processing capability, a PUSCH processing capability, a power saving capability of the terminal device, a coverage enhancement capability of the terminal device, an improvement capability of a data transmission rate of the terminal device, a processing capability of a short latency of the terminal device, a small data transmission capability of the terminal device, an inactive data transmission capability of the terminal device, a transmission reliability capability of the terminal device, or a URLLC (Ultra-reliable and Low Latency Communications) data transmission capability of the terminal device.

In some embodiments, an association between the uplink information and the TCI state information may include:
a transmission beam of the uplink information being determined according to the TCI state information.

In some embodiments, an association between the uplink information and the antenna panel information may include:
the uplink information being transmitted by an antenna panel indicated by the antenna panel information.

In some embodiments, an association between the uplink information and the TRP information may include:
the uplink information being transmitted to a TRP indicated by the TRP information.

In some embodiments, an association between the uplink information and the CORESET group information may include:
a CORESET group indicated by the CORESET group information being a CORESET group of a CORESET in which a PDCCH for triggering the uplink information is located, or a CORESET group being a CORESET group configured by a higher layer signaling for resources for transmitting the uplink information.

In some embodiments, an association between the uplink information and the reference signal set information may include:
a reference signal set associated with an antenna panel used to transmit the uplink information, or a reference signal set configured by the network device for the uplink information, or a reference signal set associated with a PDCCH corresponding to the uplink information.

In some embodiments, an association between the uplink information and the reference signal information may include:
a beam used to transmit the uplink information being determined according to a transmission beam of a reference signal indicated by the reference signal information, or being determined according to a reception beam of a reference signal indicated by the reference signal information.

In some embodiments, an association between the uplink information and the beam information may include:
the uplink information being transmitted by a beam indicated by the beam information.

In some embodiments, an association between the uplink information and the capability set information may include:
a transmission parameter of the PUSCH being determined according to the capability set information.

In some embodiments, the plurality of uplink information being associated with different spatial parameters may mean that:
the plurality of uplink information is associated with the plurality of spatial parameters, where each uplink information is associated with one spatial parameter, and the spatial parameters associated with different uplink information are different. For example, the first uplink information is associated with a first spatial parameter, and the second uplink information is associated with a second spatial parameter, where the first spatial parameter and the second spatial parameter are different.

In some embodiments, the plurality of uplink information may be scheduled by a plurality of PDCCHs, or in other words, the plurality of uplink information is scheduled by a plurality of DCI. For example, each uplink information is scheduled by one PDCCH or DCI.

In some other embodiments, the plurality of uplink information may be scheduled by one PDCCH, or in other words, the plurality of uplink information is scheduled by one DCI.

In some embodiments, the first uplink information is associated with a first TCI state, a first number of layers, a first DMRS, etc.

Herein, an association relationship between the first uplink information and the first TCI state refers to the foregoing relevant description.

In some embodiments, the first uplink information being associated with the first number of layers may mean that the number of transmission layers of the first uplink information is the first number of layers.

In some embodiments, the first uplink information being associated with the first DMRS may mean that:
the first DMRS is used to demodulate the first uplink information, or the first DMRS is used for the first uplink information, or the first DMRS is a DMRS of the first uplink information.

In some embodiments, the second uplink information is associated with a second TCI state, a second number of layers, a second DMRS, etc.

Herein, an association relationship between the second uplink information and the second TCI state refers to the foregoing relevant description.

In some embodiments, the second uplink information being associated with the second number of layers may mean that the number of transmission layers of the second uplink information is the second number of layers.

In some embodiments, the second uplink information being associated with the second DMRS may mean that:
the second DMRS is used to demodulate the second uplink information, or the second DMRS is used for the second uplink information, or the second DMRS is a DMRS of the second uplink information.

In some embodiments of the present application, the plurality of uplink information is transmitted in the SDM manner, which is referred to as an SDM transmission scheme.

Optionally, in the SDM transmission scheme, time-frequency resources corresponding to the plurality of uplink information are the same.

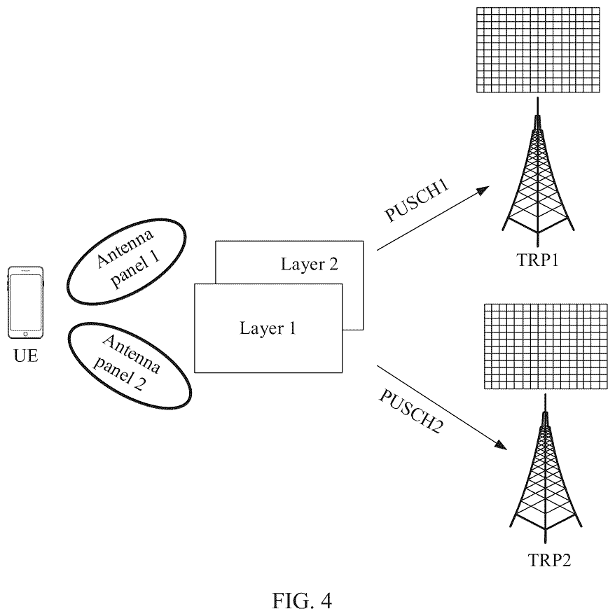

SDM scheme 1: as shown in FIG. 4, different transmission layer sets of target uplink information are associated with different spatial parameters. For example, a part of the transmission layers of the target uplink information is associated with the first spatial parameter, and this part of the transmission layers is noted as the first uplink information. Another part of the transmission layers of the target uplink information is associated with the second spatial parameter, and the another part of the transmission layers is noted as the second uplink information.

Taking an example in which the target uplink information is the PUSCH and the spatial parameter is the TCI state, different transmission layer sets of one PUSCH may be transmitted to different TRPs by different panels of the terminal device. For example, different transmission layer sets transmitted to different TRPs by different panels may be considered as different uplink information. For example, a part of the transmission layers of the PUSCH transmitted by a panel1 is associated with a first TCI state, noted as the first uplink information, and another part of the transmission layers of the PUSCH transmitted by a panel2 is associated with a second TCI state, noted as the second uplink information.

SDM scheme 2: repeated transmissions of target uplink information (which may be different redundancy versions (RV)) are associated with different spatial parameters. That is, the plurality of uplink information is repeated transmissions of the target uplink information associated with different spatial parameters.

Taking an example in which the target uplink information is the PUSCH, repeated transmissions of one PUSCH are transmitted to different TRPs by different panels of the UE. For example, the PUSCH transmitted by panel 1 of the UE is noted as the first uplink information, and the PUSCH transmitted by panel 2 of the UE is noted as the second uplink information.

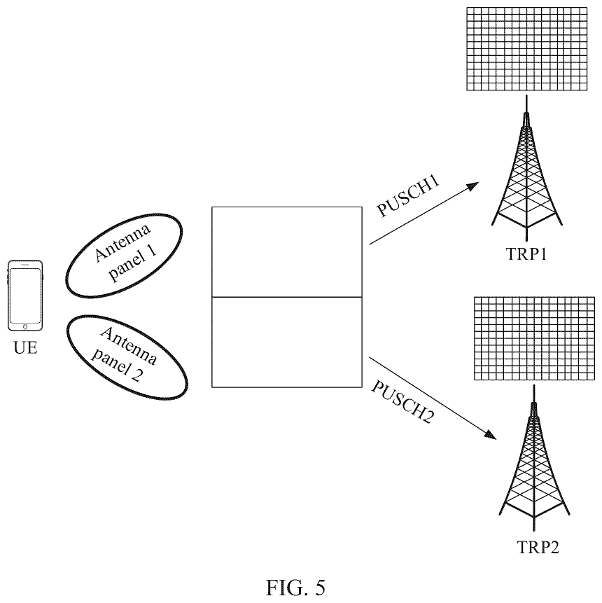

In some embodiments of the present application, as shown in FIG. 5, the plurality of uplink information is transmitted in the FDM manner, which is referred to as an FDM transmission scheme.

Optionally, in the FDM transmission scheme, time domain resources of the plurality of uplink information are the same, frequency domain resources of the plurality of uplink information do not overlap with each other.

FDM scheme 1: repeated transmissions of the target uplink information (which may be different RVs or a same RV) are associated with different spatial parameters. That is, the plurality of uplink information is repeated transmissions of the target uplink information associated with different spatial parameters.

Taking an example in which the target uplink information is the PUSCH, repeated transmissions of one PUSCH are transmitted to different TRPs by different panels of the UE. For example, the PUSCH transmitted by panel 1 of the UE is noted as the first uplink information, and the PUSCH transmitted by panel 2 of the UE is noted as the second uplink information.

FDM scheme 2: different parts of the target uplink information are associated with different spatial parameters, i.e., the plurality of uplink information is different parts of the target uplink information associated with different spatial parameters.

Taking an example in which the target uplink information is the PUSCH, different parts (such as different information bits) of one PUSCH are transmitted to different TRPs by different panels of the UE. For example, a part of the PUSCH transmitted by panel 1 of the UE is noted as the first uplink information, and a part of the PUSCH transmitted by panel 2 of the UE is noted as the second uplink information.

In some embodiments of the present application, the plurality of uplink information is transmitted in a single frequency network (SFN) manner, which is referred to as an SFN transmission scheme.

Optionally, in the SFN transmission scheme, time domain resources of the plurality of uplink information are the same, frequency domain resources of the plurality of uplink information are the same, and DMRS ports of the plurality of uplink information are also the same.

In a specific SFN transmission scheme, repeated transmissions of the target uplink information are associated with different spatial parameters. That is, the plurality of uplink information is repeated transmissions of the target uplink information associated with different spatial parameters.

Taking an example in which the target uplink information is the PUSCH, repeated transmissions of one PUSCH are transmitted to different TRPs by different panels of the UE. For example, the PUSCH transmitted by panel 1 of the UE is noted as the first uplink information, and the PUSCH transmitted by panel 2 of the UE is noted as the second uplink information.

It should be understood that determining, by the terminal device, the port information of the demodulation reference signal (DMRS) and/or the transmission layer number information of the plurality of uplink information according to the target antenna port indication information, corresponds to generating, by the network device, the target antenna port indication information to indicate that the port information of the demodulation reference signal (DMRS) and/or the transmission layer number information of the plurality of uplink information. The following is explained, by taking an example in which the terminal device determines the port information of the demodulation reference signal (DMRS) and/or the transmission layer number information of the plurality of uplink information according to the target antenna port indication information, and the description on the network device side corresponds to the description on the terminal device side, which will not be repeated here for the sake of brevity.

In some embodiments, the target antenna port indication information may be indicated by a signaling, such as DCI, an RRC signaling, an MAC signaling, or a broadcast message, etc. The following is explained, by taking an example in which the target antenna port indication information is indicated by the DCI. When the target antenna port indication information is indicated by other signalings, the design manner is similar, which will not be repeated here.

Optionally, the target antenna port indication information may be indicated by an existing field in the signaling, for example, by using a reserved bit in the existing field, or the target antenna port indication information may also be indicated by a newly added field in the signaling, which is not limited to the present application.

Optionally, a size of a field of the target antenna port indication information may be determined according to the amount of the DMRS port information and/or the transmission layer number information to be indicated.

Optionally, in some embodiments, when the target antenna port indication information is only used to determine the DMRS port information of the plurality of uplink information, the transmission layer number information of the plurality of uplink information may be determined according to other indication information or configuration information, or the transmission layer number information of the plurality of uplink information may be determined according to a number of ports of the DMRS of the uplink information, for example, the number of ports of the DMRS of the uplink information is determined as the number of transmission layers of the uplink information.

Optionally, in the embodiments of the present application, the DMRS port information of the uplink information may include the number of DMRS ports and/or indication information of the DMRS ports, such as the index of the DMRS port.

In the embodiments of the present application, the port of the DMRS is also referred to as a DMRS port, and similarly, the port of the PT-RS is also referred to as a PT-RS port.

It should be noted that the present application is explained only by taking an example in which determining the port information of the DMRS and/or the transmission layer number information of the first uplink information and the second uplink information according to the target antenna port indication information. When the plurality of uplink information includes more uplink information, the determining manner is similar, which will not be repeated here.

In the embodiments of the present application, the port information of the DMRS of the first uplink information is noted as port information of a first DMRS, or referred to as first DMRS port information, and the port information of the DMRS of second uplink information is noted as port information of a second DMRS, or referred to as second DMRS port information, where the first DMRS is associated with the first uplink information, and the second DMRS is associated with the second uplink information.

In some embodiments, the port information of the first DMRS includes a number of ports and/or port indication information of the first DMRS, such as a port index.

In some embodiments, the port information of the second DMRS includes a number of ports and/or port indication information of the second DMRS, such as a port index.

In the following, a manner for determining the port information of the demodulation reference signal (DMRS) and/or the transmission layer number information of the plurality of uplink information is explained in conjunction with some embodiments.

Embodiment 1: DMRS port information of each uplink information is determined by separate antenna port indication information.

Optionally, in this embodiment 1, the transmission layer number information of the plurality of uplink information may be acquired by other configuration information or other indication information except the target antenna port indication information, for example, acquired by a TPMI or an SRI, or acquired by layer number indication information.

Optionally, the transmission layer number information of first uplink information and the transmission layer number information of second uplink information may be acquired by same configuration information or indication information, or may also be acquired by different configuration information or indication information, which is not limited to the present application.

For example, the transmission layer number information of the first uplink information and the transmission layer number information of the second uplink information are acquired by separate layer number indication information, or may also be acquired by same layer number indication information.

In some embodiments, the target antenna port indication information includes first antenna port indication information and second antenna port indication information, the port information of the first DMRS is determined according to the first antenna port indication information, and the port information of the second DMRS is determined according to the second antenna port indication information.

In some embodiments, the first antenna port indication information is associated with a first spatial parameter, and the second antenna port indication information is associated with a second spatial parameter. That is, the DMRS port information of the first uplink information associated with the first spatial parameter is determined according to the first antenna port indication information, and the DMRS port information of the second uplink information associated with the second spatial parameter is determined according to the second antenna port indication information.

In some embodiments, the first antenna port indication information and the second antenna port indication information correspond to two fields in the DCI.

For example, the first antenna port indication information corresponds to a first antenna port field, and the second antenna port indication information corresponds to a second antenna port field.

That is, in this embodiment 1, the DMRS port information of different uplink information may be indicated by separate fields, respectively, which is helpful to reduce the implementation complexity of the terminal device and the network device.

In some embodiments, the port information of the first DMRS is determined according to the first antenna port indication information and a first transmission parameter, where the first transmission parameter is associated with the first uplink information.

Optionally, an association between the first transmission parameter and the first uplink information may include: the first transmission parameter being used to transmit a DMRS of the first uplink information and/or the first uplink information. That is, the first transmission parameter may include a transmission parameter of the first uplink information, or may also include a transmission parameter of the DMRS of the first uplink information.

In some embodiments, the port information of the second DMRS is determined according to the second antenna port indication information and a second transmission parameter, where the second transmission parameter is associated with the second uplink information.

Optionally, an association between the second transmission parameter and the second uplink information may include: the second transmission parameter being used to transmit a DMRS of the second uplink information and/or the second uplink information. That is, the second transmission parameter may include a transmission parameter of the second uplink information, or may also include a transmission parameter of the DMRS of the second uplink information.

As an example, the first transmission parameter includes but is not limited to at least one of:
a first number of layers, a type of the first DMRS, a maximum number of symbols of the first DMRS, or a number of DMRS CDM groups.

As an example, the second transmission parameter includes at least one of:
a second number of layers, a type of the second DMRS, a maximum number of symbols of the second DMRS, or a number of DMRS CDM groups.

In some embodiments, the first transmission parameter is configured or indicated by the network device, and the second transmission parameter is configured or indicated by the network device.

For example, the network device may configure or indicate the first transmission parameter and the second transmission parameter by at least one of the following signalings: an RRC signaling, a Media Access Control Control Element (MAC CE), or DCI.

It should be understood that the first transmission parameter and the second transmission parameter may be configured or indicated by a same signaling, or may also be configured or indicated by different signalings, which is not limited to the present application.

In some embodiments, the number of ports of the first DMRS is the same as the first number of layers.

In some embodiments, the number of ports of the second DMRS is the same as the second number of layers.

In some embodiments, a port of the first DMRS and a port of the second DMRS are in different DMRS CDM groups.

In some embodiments, a sum of the first number of layers and the second number of layers does not exceed 4, and a layer number combination of the first number of layers and the second number of layers may include at least one of the following layer number combinations:
a first layer number combination: the first number of layers and the second number of layers being both 1;
a second layer number combination: the first number of layers is 2, the second number of layers is 1;
a third layer number combination: the first number of layers is 1, the second number of layers is 2;
a fourth layer number combination: the first number of layers is 2, the second number of layers is 2;
a fifth layer number combination: the first number of layers is 1, the second number of layers is 3; or
a sixth layer number combination: the first number of layers is 3, the second number of layers is 1.

In some embodiments, when the layer number combination of the first number of layers and the second number of layers is the first layer number combination, the second layer number combination, the third layer number combination, or the fourth layer number combination, the port of the first DMRS determined according to the first antenna port indication information and the port of the second DMRS determined according to the second antenna port indication information belong to different DMRS CDM groups, the number of symbols of the first DMRS is 1, and the number of symbols of the second DMRS is 1.

In some embodiments, when the layer number combination of the first number of layers and the second number of layers is the fifth layer number combination, the port of the first DMRS determined according to the first antenna port indication information and the port of the second DMRS determined according to the second antenna port indication information belong to different DMRS CDM groups, the number of symbols of the first DMRS is 1, and the number of symbols of the second DMRS is 2.

In some embodiments, when the layer number combination of the first number of layers and the second number of layers is the sixth layer number combination, the port of the first DMRS determined according to the first antenna port indication information and the port of the second DMRS determined according to the second antenna port indication information belong to different DMRS CDM groups, the number of symbols of the first DMRS is 2, and the number of symbols of the second DMRS is 1.

In some embodiments, the terminal device may obtain a plurality of correspondences, where each correspondence corresponds to a type of the number of transmission layers, and each correspondence includes a correspondence between a state value of antenna port indication information and port information of a DMRS.

In some embodiments, the plurality of correspondences may be predefined, or may also be configured by the network device.

In some embodiments, the plurality of correspondences may include a correspondence corresponding to the number of transmission layers of 1, a correspondence corresponding to the number of transmission layers of 2, and a correspondence corresponding to the number of transmission layers of 3.

It should be understood that the present application does not limit the representation manner of the plurality of correspondences. For example, the plurality of correspondences may be represented by using a table, or may also be represented by using a sentence, a text, or a code, which is not limited to the present application.

In this embodiment 1, layer number information corresponding to the first antenna port indication information is the first number of layers, and layer number information corresponding to the second antenna port indication information is the second number of layers. That is, when the terminal device determines the port information of the first DMRS according to the first antenna port indication information, the terminal device uses the correspondence corresponding to the first number of layers; when the terminal device determines the port information of the second DMRS according to the second antenna port indication information, the terminal device uses the correspondence corresponding to the second number of layers.

In some embodiments, determining, by the terminal device, the port information of the first DMRS according to the first antenna port indication information, includes:
determining a first correspondence in a plurality of correspondences according to the first number of layers, where the first correspondence corresponds to the first number of layers, and the first correspondence includes a correspondence between a state value of antenna port indication information and port information of a DMRS;
determining the port information of the first DMRS according to the first antenna port indication information and the first correspondence.

For example, the port information of the DMRS corresponding to the state value of the first antenna port indication information in the first correspondence is used as the port information of the first DMRS.

In some embodiments, determining, by the terminal device, the port information of the second DMRS according to the second antenna port indication information, includes:
determining a second correspondence in a plurality of correspondences according to the second number of layers, where the second correspondence corresponds to the second number of layers, and the second correspondence includes a correspondence between a state value of antenna port indication information and port information of a DMRS;
determining the port information of the second DMRS according to the second antenna port indication information and the second correspondence.

For example, the port information of the DMRS corresponding to the state value of the second antenna port indication information in the second correspondence is used as the port information of the second DMRS.

It should be noted that, for the first antenna port indication information and the second antenna port indication information, the plurality of correspondences may be shared, and it is only necessary to use a respective correspondence according to the layer number information corresponding to each antenna port indication information. Or, for the first antenna port indication information and the second antenna port indication information, the plurality of correspondences may be independent, and the respective plurality of correspondences are used when determining the port information of the DMRS according to different antenna port indication information. Optionally, the plurality of correspondences corresponding to different antenna port indication information may be the same, or may be different, but it is necessary to ensure that two DMRS ports determined according to the antenna port indication information are in different DMRS CDM groups.

In the following, the implementation of the correspondence under different transmission parameters is explained in conjunction with some examples.

### Example 1

In some embodiments, in a case where the first number of layers or the second number of layers is 1, the type of the first DMRS is type 1, and the maximum number of symbols of the first DMRS is 1, in the first correspondence or the second correspondence, the state value of the antenna port indication information is used to indicate at least one of the following DMRS ports: DMRS port 0, DMRS port 1, DMRS port 2, or DMRS port 3.

The implementation of Example 1 is explained, by taking an example in which the first correspondence and the second correspondence are represented by a table.

When the first number of layers or the second number of layers is 1, the layer number information corresponding to the first antenna port indication information or the second antenna port indication information is 1 layer, when transmission precoding (Transmit Precoding) is disabled, the DMRS type is type 1 (i.e., dmrs-Type=1), and the maximum number of symbols of the DMRS is 1 (maxLength=1), a table corresponding to the first antenna port indication information or the second antenna port indication information may be shown as Table 4.

TABLE 4

| State | Number of DMRS CDM | DMRS |
|---|---|---|
| value | group(s) without data | port |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

For example, when the first DMRS port determined according to the state value of the first antenna port indication information belongs to the CDM group 0, the second DMRS port determined according to the state value of the second antenna port indication information is port 2 or port 3.

For another example, when the first DMRS port determined according to the state value of the first antenna port indication information belongs to the CDM group 1, the second DMRS port determined according to the state value of the second antenna port indication information is port 0 or port 1.

### Example 2

In some embodiments, when the first number of layers or the second number of layers is 2, the type of the first DMRS is type 1, and the maximum number of symbols of the first DMRS is 1, in the first correspondence or the second correspondence, the state value of the antenna port indication information is used to indicate at least one of the following DMRS ports:
DMRS ports 0, 1 (the number of DMRS CDM groups without transmitting data is 1);
DMRS ports 0, 1 (the number of DMRS CDM groups without transmitting data is 2); or
DMRS ports 2, 3.

The implementation of Example 2 is explained, by taking an example in which the first correspondence and the second correspondence are represented by a table.

When the first number of layers or the second number of layers is 2, the layer number information corresponding to the first antenna port indication information or the second antenna port indication information is 2 layers, when transmission precoding (Transmit Precoding) is disabled, the DMRS type is type 1 (i.e., dmrs-Type=1), and the maximum number of symbols of the DMRS is 1 (maxLength=1), a table corresponding to the first antenna port indication information or the second antenna port indication information may be shown as Table 5. For example, when the first DMRS port determined according to the state value of the first antenna port indication information is port 0 and port 1, the second DMRS port determined according to the state value of the second antenna port indication information is port 2 and port 3. For another example, when the first DMRS port determined according to the state value of the first antenna port indication information is port 2 and port 3, the second DMRS port determined according to the state value of the second antenna port indication information is port 0 and port 1.

TABLE 5

| State | Number of DMRS CDM | DMRS |
|---|---|---|
| value | group(s) without data | port |
| 0 | 1 | 0, 1 |
| 1 | 2 | 0, 1 |
| 2 | 2 | 2, 3 |
| 3-7 | Reserved | Reserved |

### Example 3

In some embodiments, when the first number of layers or the second number of layers is 3, the type of the first DMRS is type 1, and the maximum number of symbols of the first DMRS is 2, in the first correspondence or the second correspondence, the state value of the antenna port indication information is used to indicate at least one of the following DMRS ports:
DMRS ports 0, 1, 4; or
DMRS ports 2, 3, 6.

The implementation of Example 3 is explained, by taking an example in which the first correspondence and the second correspondence are represented by a table.

When the first number of layers or the second number of layers is 3, the layer number information corresponding to the first antenna port indication information or the second antenna port indication information is 3 layers, when transmission precoding (transform precoder) is disabled, the DMRS type is type 1 (i.e., dmrs-Type=1), and the maximum number of symbols of the DMRS is 2 (maxLength=2), a table corresponding to the first antenna port indication information or the second antenna port indication information may be shown as Table 6 below. For example, when the first number of layers is 1 and the second number of layers is 3, and the first DMRS port determined according to the state value of the first antenna port indication information is port 0 (which may be determined according to Table 4), the second DMRS port determined according to the state value of the second antenna port indication information are port 2, port 3, port 6. For another example, when the first number of layers is 3 and the second number of layers is 1, and the first DMRS port determined according to the state value of the first antenna port indication information is port 0, port 1, port 4, the second DMRS port determined according to the state value of the second antenna port indication information is port 3 (which may be determined according to Table 4).

TABLE 6

| | Number of DMRS CDM | |
|---|---|---|
| State value | group(s) without data | DMRS port |
| 0 | 2 | 0, 1, 4 (CDM group1) |
| 1 | 2 | 2, 3, 6 (CDM group2) |
| 1-7 | Reserved | Reserved |

### Example 4

In some embodiments, when the first number of layers or the second number of layers is 3, the type of the first DMRS is type 2, and the maximum number of symbols of the first DMRS is 2, in the first correspondence or the second correspondence, the state value of the antenna port indication information is used to indicate at least one of the following DMRS ports:
DMRS ports 0, 1, 6;
DMRS ports 2, 3, 8; or
DMRS ports 4, 5, 10.

The implementation of Example 4 is explained, by taking an example in which the first correspondence and the second correspondence are represented by a table.

When the first number of layers or the second number of layers is 3, the layer number information corresponding to the first antenna port indication information or the second antenna port indication information is 3 layers, when transmit precoding (transform precoder) is disabled, the DMRS type is type 2 (i.e., dmrs-Type=2), and the maximum number of symbols of the DMRS is 2 (maxLength=2), a table corresponding to the first antenna port indication information or the second antenna port indication information may be shown as Table 7 below.

For example, when the first number of layers is 1, the second number of layers is 3, and the first DMRS port determined according to the state value of the first antenna port indication information is port 0 (which may be determined according to Table 4), the second DMRS port determined according to the state value of the second antenna port indication information is port 2, port 3, port 8.

For another example, when the first number of layers is 3, the second number of layers is 1, and the first DMRS port determined according to the state value of the first antenna port indication information is port 0, port 1, port 6, the second DMRS port determined according to the state value of the second antenna port indication information may be port 3 (which may be determined according to Table 4).

TABLE 7

| | Number of DMRS CDM | |
|---|---|---|
| State value | group(s) without data | DMRS port |
| 0 | 2 | 0, 1, 6 (CDM group1) |
| 1 | 2 | 2, 3, 8 (CDM group2) |
| 2 | 2 | 4, 5, 10 (CDM group3) |
| 3-7 | Reserved | Reserved |

In some embodiments of the present application, the terminal device may also determine a codeword transmission mode for the first uplink information and the second uplink information, and determine a mapping mode between the codeword and the transmission layer according to the codeword transmission mode and the number of DMRS CDM groups.

For example, if the codeword transmission mode is a dual-codeword transmission, a CDM group corresponding to the first DMRS and a CDM group corresponding to the second DMRS are mapped to one codeword, respectively. For example, codeword 0 is associated with a port of the first DMRS, and codeword 1 is associated with a port of the second DMRS.

For another example, if the codeword transmission mode is a single-codeword transmission, a CDM group corresponding to the first DMRS and a CDM group corresponding to the second DMRS are mapped to a same codeword, for example, both are associated with codeword 0.

In some embodiments, the first uplink information and the second uplink information include different transmission layer sets of the target uplink information, and a transmission layer set associated with the first spatial parameter and a transmission layer set associated with the second spatial parameter are mapped to different codewords.

Embodiment 2: the DMRS port information and the transmission layer number information of the plurality of uplink information are determined by one antenna port indication information.

In some embodiments, target antenna port indication information includes third antenna port indication information, and port information of a first DMRS, port information of a second DMRS, a first number of layers, and a second number of layers are determined according to the third antenna port indication information.

In some embodiments, the third antenna port indication information corresponds to an antenna port field in DCI.

Therefore, in this embodiment 2, there is no need to add an additional field in the DCI. Instead, the DMRS port information and the transmission layer number information of the plurality of uplink information are determined by re-interpreting the antenna port field in the DCI, which is beneficial to reducing the DCI overhead.

In some embodiments, the port information of the first DMRS, the port information of the second DMRS, the first number of layers, and the second number of layers are determined according to the third antenna port indication information and a third transmission parameter. Herein, the third transmission parameter includes a transmission parameter of the first uplink information and a transmission parameter of the second uplink information.

In some embodiments, the number of ports of the first DMRS is the same as the first number of layers.

In some embodiments, the number of ports of the second DMRS is the same as the second number of layers.

In some embodiments, the third transmission parameter includes but is not limited to at least one of:
a type of the first DMRS, a maximum number of symbols of the first DMRS, a type of the second DMRS, a maximum number of symbols of the second DMRS, or a number of DMRS CDM groups, where the type of the first DMRS and the maximum number of symbols of the first DMRS are associated with the first uplink information, and the type of the second DMRS and the maximum number of symbols of the second DMRS are associated with the second uplink information.

In some embodiments, the third antenna port indication information is used to indicate at least one of the following states:
the port information of the first DMRS, the port information of the second DMRS, a port of the first DMRS and a port of the second DMRS being in different CDM groups, and a first layer number combination: the first number of layers and the second number of layers being both 1;
the port information of the first DMRS, the port information of the second DMRS, the port of the first DMRS and the port of the second DMRS being in different CDM groups, and a second layer number combination: the first number of layers being 2 and the second number of layers being 1;
the port information of the first DMRS, the port information of the second DMRS, the port of the first DMRS and the port of the second DMRS being in different CDM groups, and a third layer number combination: the first number of layers being 1 and the second number of layers being 2;
the port information of the first DMRS, the port information of the second DMRS, the port of the first DMRS and the port of the second DMRS being in different CDM groups, and a fourth layer number combination: the first number of layers being 2 and the second number of layers being 2;
the port information of the first DMRS, the port information of the second DMRS, the port of the first DMRS and the port of the second DMRS being in different CDM groups, and a fifth layer number combination: the first number of layers being 1 and the second number of layers being 3; or
the port information of the first DMRS, the port information of the second DMRS, the port of the first DMRS and the port of the second DMRS being in different CDM groups, and a sixth layer number combination: the first number of layers being 3 and the second number of layers being 1.

The number of ports of the first DMRS is the same as the first number of layers, and the number of ports of the second DMRS is the same as the second number of layers;
the port of the first DMRS and the port of the second DMRS belong to different CDM groups;
when the first number of layers is 3, the number of symbols of the first DMRS is 2;
when the first number of layers is 1 or 2, the number of symbols of the first DMRS is 1;
when the second number of layers is 3, the number of symbols of the second DMRS is 2;
when the second number of layers is 1 or 2, the number of symbols of the second DMRS is 1;
the terminal device determines the codeword transmission mode for the first uplink information and the second uplink information, and determines the mapping mode (for the mapping mode, refer to the relevant description in Embodiment 1) between the codeword and the transmission layer according to the codeword transmission mode for the first uplink information and the second uplink information, and the number of DMRS CDM groups.

That is, in this embodiment 2, the DMRS port information and the transmission layer number information of the uplink information may be determined directly according to the state value of the third antenna port indication information.

In some embodiments, a correspondence between the state value of the third antenna port indication information and the DMRS port information and the transmission layer number information may be represented by a table, or may be represented by a sentence, a text or a code, etc., which is not limited to the present application.

In some embodiments, the third antenna port indication information is used to indicate a group of DMRS ports, including a port of the first DMRS and a port of the second DMRS. The ports included in the port of the first DMRS and in the port of the second DMRS may be determined according to the first number of layers and the second number of layers (where the number of ports of the first DMRS is the same as the first number of layers, and the number of ports of the second DMRS is the same as the second number of layers), and it is necessary to ensure that the port of the first DMRS and the port of the second DMRS are in different CDM groups.

The implementation of the correspondence is explained below, by taking an example in which the correspondence between the state value of the third antenna port indication information, and the DMRS port information, and the transmission layer number information is represented by a table.

### Example A

When transmission precoding is disabled, the DMRS type is type 1 (dmrs-Type=1), and the maximum number of DMRS symbols is 1 (maxLength=1), the third antenna port indication information is used to indicate the port information of the first DMRS and the port information of the second DMRS, as well as the layer number combination of the first number of layers and the second number of layers. Table 8 shows an example of the correspondence under this transmission parameter, but the present application is not limited thereto.

TABLE 8

| State | Number of DMRS CDM | Layer number | DMRS |
|---|---|---|---|
| value | group(s) without data | combination | port |
| 0 | 2 | First layer number | 0; 2 |
| | | combination | |
| 1 | 2 | Second layer number | 0, 1; 2 |
| | | combination | |
| 2 | 2 | Third layer number | 0; 2, 3 |
| | | combination | |
| 3 | 2 | Fourth layer number | 0, 1; 2, 3 |
| | | combination | |

### Example B

When transmission precoding is disabled, the DMRS type is type 1, and the maximum number of DMRS symbols is 2, the third antenna port indication information is used to indicate the port information of the first DMRS and the port information of the second DMRS, as well as the layer number combination of the first number of layers and the second number of layers. Table 9 shows an example of the correspondence under this transmission parameter, but the present application is not limited thereto.

TABLE 9

| | Number of DMRS | | | |
|---|---|---|---|---|
| | CDM group(s) | | DMRS | Number of pre- |
| State value | without data | Layer number combination | port | DMRS symbols |
| 0 | 2 | First layer number combination | 0; 2 | 1 |
| 1 | 2 | Second layer number combination | 0, 1; 2 | 1 |
| 2 | 2 | Third layer number combination | 0; 2, 3 | 1 |
| 3 | 2 | Fourth layer number combination | 0, 1; 2, 3 | 1 |
| 4 | 2 | Fifth layer number combination | 0; 2, 3, 6 | 2 |
| 5 | 2 | Sixth layer number combination | 0, 1, 4; 2 | 2 |
| 6-7 | Reserved | | Reserved | Reserved |

### Example C

When transmission precoding is disabled, the DMRS type is type 2, and the maximum number of DMRS symbols is 1, the third antenna port indication information is used to indicate the port information of the first DMRS and the port information of the second DMRS, as well as the layer number combination of the first number of layers and the second number of layers. Table 10 shows an example of the correspondence under this transmission parameter, but the present application is not limited thereto.

TABLE 10

| State | Number of DMRS CDM | Layer number | DMRS |
|---|---|---|---|
| value | group(s) without data | combination | port |
| 0 | 2 | First layer number | 0; 2 |
| | | combination | |
| 1 | 2 | First layer number | 0; 4 |
| | | combination | |
| 2 | 2 | Second layer number | 0, 1; 2 |
| | | combination | |
| 3 | 2 | Second layer number | 0, 1; 2 |
| | | combination | |
| 4 | 3 | Second layer number | 3, 4; 5 |
| | | combination | |
| 5 | 2 | Third layer number | 0; 2, 3 |
| | | combination | |
| 6 | 2 | Fourth layer number | 0, 1; 2, 3 |
| | | combination | |
| 7 | Reserved | Reserved | Reserved |

### Example D

When transmission precoding is disabled, the DMRS type is type 2, and the maximum number of DMRS symbols is 2, the third antenna port indication information is used to indicate the port information of the first DMRS and the port information of the second DMRS, as well as the layer number combination of the first number of layers and the second number of layers. Table 11 shows an example of the correspondence under this transmission parameter, but the present application is not limited thereto.

TABLE 11

| | Number of DMRS | | | |
|---|---|---|---|---|
| | CDM group(s) | | DMRS | Number of pre- |
| State value | without data | Layer number combination | port | DMRS symbols |
| 0 | 2 | first layer number combination | 0; 2 | 1 |
| 1 | 2 | second layer number combination | 0, 1; 2 | 1 |
| 2 | 2 | Third layer number combination | 0; 2, 3 | 1 |
| 3 | 2 | Fourth layer number combination | 0, 1; 2, 3 | 1 |
| 4 | 3 | Fifth layer number combination | 0; 2, 3, 8 | 2 |
| 5 | 3 | Sixth layer number combination | 0, 1, 6; 2 | 2 |
| 6-7 | Reserved | | Reserved | Reserved |

It should be understood that the correspondence between the state value and the DMRS port information illustrated in Table 10 and Table 11 is only an example. In actual applications, the contents in the tables may also be deleted, adjusted or added. For example, in Table 11, the DMRS ports corresponding to the state value of 1 may be 0, 1, 3, and the DMRS ports corresponding to the state value of 2 may be 1, 2, 3, as long as the DMRS ports of the two uplink information can be located in different CDM groups. Or, when more layers are supported, there may be more layer number combinations, and the table may also indicate DMRS port information under more layer number combinations.

For example, when transmission precoding is disabled, the DMRS type is type 2, and the maximum number of DMRS symbols is 2, the terminal device may use the correspondence in Table 11 to determine the port information of the first DMRS, the port information of the second DMRS, and the first number of layers and the second number of layers. If the state value of the third antenna port indication information is 2, the port information of the first DMRS and the port information of the second DMRS include DMRS ports 0, 2, 3, and the second layer number combination is the first number of layers of 2 and the second number of layers of 1, then the port of the first DMRS includes 2 ports, the port of the second DMRS includes 1 port, and the port of the first DMRS and the port of the second DMRS are in different CDM groups. Based on this, it may be determined that the port of the first DMRS is ports 2, 3, and the port of the second DMRS includes port 0.

For another example, when transmission precoding is disabled, the DMRS type is type 1, and the maximum number of DMRS symbols is 2, the terminal device may use the correspondence in Table 9 to determine the port information of the first DMRS, the port information of the second DMRS, and the first number of layers and the second number of layers. If the state value of the third antenna port indication information is 4, the port information of the first DMRS and the port information of the second DMRS include DMRS ports 0; 2, 3, 6, and the fifth layer number combination is the first number of layers of 1 and the second number of layers of 3, then the port of the first DMRS includes 1 port, the port of the second DMRS includes 3 ports, and the port of the first DMRS and the port of the second DMRS are in different CDM groups. Based on this, it may be determined that the port of the first DMRS is port 0, and the port of the second DMRS includes ports 2, 3, 6.

Embodiment 3: DMRS port information of the plurality of uplink information is determined by one antenna port indication information.

Optionally, in this embodiment 3, the transmission layer number information of the plurality of uplink information may be acquired by other configuration information or other indication information except the target antenna port indication information, for example, acquired by a TPMI or an SRI, or acquired by layer number indication information.

Optionally, the transmission layer number information of the first uplink information and the transmission layer number information of the second uplink information may be acquired by same configuration information or indication information, or may be acquired by different configuration information or indication information, which is not limited to the present application.

For example, the transmission layer number information of the first uplink information and the transmission layer number information of the second uplink information are acquired by separate layer number indication information, or may be acquired by same layer number indication information.

In some embodiments, the target antenna port indication information includes fourth antenna port indication information, and the port information of the first DMRS and the port information of the second DMRS are determined according to the fourth antenna port indication information.

In some embodiments, the fourth antenna port indication information corresponds to an antenna port field in DCI.

Therefore, in this embodiment 3, there is no need to add an additional field in the DCI. Instead, the DMRS port information of the plurality of uplink information is determined by re-interpreting the antenna port field in the DCI, which is beneficial to reducing the DCI overhead.

In some embodiments, the port of the first DMRS and the port of the second DMRS are in different DMRS CDM groups.

In some embodiments, the number of ports of the first DMRS is the same as the first number of layers.

In some embodiments, the number of ports of the second DMRS is the same as the second number of layers.

In some embodiments, a type of the first DMRS is the same as a type of the second DMRS.

In some embodiments, a maximum number of symbols of the first DMRS is the same as a maximum number of symbols of the second DMRS.

In some embodiments, the port information of the first DMRS and the port information of the second DMRS are determined according to fourth antenna port indication information and a fourth transmission parameter, where the fourth transmission parameter includes a transmission parameter of first uplink information and a transmission parameter of second uplink information.

In some embodiments, the fourth transmission parameter includes but is not limited to at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
where the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.

That is, in this embodiment 3, the layer number information corresponding to the fourth antenna port indication information is the sum of the first number of layers and the second number of layers, that is, when determining the port information of the first DMRS and the port information of the second DMRS according to the fourth antenna port indication information, a correspondence of the sum of the first number of layers and the second number of layers is used.

In some embodiments, determining, by the terminal device, the port information of the first DMRS and the port information of the second DMRS according to the fourth antenna port indication information, includes:
determining a third correspondence in a plurality of correspondences according to a sum of a first number of layers and a second number of layers, where the plurality of correspondences correspond to different number of transmission layers, respectively, the third correspondence corresponds to the sum of the first number of layers and the second number of layers, and the third correspondence includes a correspondence between a state value of antenna port indication information, and port information of the first DMRS and port information of the second DMRS;
determining the port information of the first DMRS and the port information of the second DMRS according to the fourth antenna port indication information and the third correspondence.

For example, the port information of the first DMRS and the port information of the second DMRS are determined according to the port information of the DMRS corresponding to the state value of the fourth antenna port indication information in the third correspondence.

In some embodiments, the sum of the first number of layers and the second number of layers may be 2, 3, or 4, then the plurality of correspondences may include a correspondence corresponding to the number of the transmission layers of 2, a correspondence corresponding to the number of the transmission layers of 3, and a correspondence corresponding to the number of the transmission layers of 4.

It should be understood that the present application does not limit the representation manner of the plurality of correspondences. For example, the plurality of correspondences may be represented by a table, or may also be represented by a sentence, a text or a code, which is not limited to the present application.

In the following, in conjunction with some examples, the manner for determining the port of the first DMRS and the port of the second DMRS in Embodiment 3 is explained.

Manner 1: The port of the first DMRS and the port of the second DMRS belong to different CDM groups.

In some embodiments, in the third correspondence, each state value is used to indicate a group of DMRS ports, then the terminal device may determine the port of the first DMRS and the port of the second DMRS according to the port of the first DMRS and the port of the second DMRS being in different CDM groups, and sizes of the first number of layers and the second number of layers, where the number of ports included in the port of the first DMRS is the same as the first number of layers, and the number of ports included in the port of the second DMRS is the same as the second number of layers.

The implementation of the third correspondence is explained below, by taking an example in which the third correspondence is represented by a table.

### Example H

If the first number of layers is 1 and the second number of layers is 2, the sum of the first number of layers and the second number of layers is 3, and the layer number information corresponding to the fourth antenna port indication information is 3, then the fourth antenna port indication information corresponds to a table with the number of layers of 3, where the table with the number of layers of 3 may be as shown in Table 12. For example, if the state value of the fourth antenna port indication information is 0, indicating DMRS ports 0, 1, and 2, where the DMRS ports 0 and 1 belong to a same DMRS CDM group and the DMRS port 2 belongs to another DMRS CDM group, then the port of the first DMRS is 2 and the port of the second DMRS is 0 and 1.

TABLE 12

| State | Number of DMRS CDM | DMRS | Number of pre- |
|---|---|---|---|
| value | group(s) without data | port | DMRS symbols |
| 0 | 2 | 0, 1, 2 | 1 |
| 1 | 2 | 0, 1, 4 | 2 |
| 2 | 2 | 2, 3, 6 | 2 |
| 3-15 | Reserved | Reserved | Reserved |

Manner 2: the first DMRS and the second DMRS are located on different symbols in time domain, where the first DMRS is associated with the first uplink information, and the second DMRS is associated with the second uplink information.

For example, when the maximum number of DMRS symbols is 2, the first DMRS and the second DMRS are located on different symbols in time domain.

As an example, if the number of DMRS symbols corresponding to the fourth antenna port indication information is 2, the first DMRS is associated with a DMRS port corresponding to one of the symbols, and the second DMRS port is associated with a DMRS port corresponding to another symbol.

In some embodiments, the terminal device may determine a codeword transmission mode for the first uplink information and the second uplink information, and further determine a mapping relationship from a codeword to a layer according to the first number of layers and the second number of layers.

In some cases, the first uplink information and the second uplink information are different transmission layer sets of the target uplink information. For example, if the target uplink information includes a transmission layer 1 and a transmission layer 2, the first uplink information and the second uplink information may include a transmission layer, respectively.

Then, the terminal device may map the transmission layers associated with different spatial parameters to different codewords. For example, a transmission layer of the first uplink information associated with a first spatial parameter and a transmission layer of the second uplink information associated with a second spatial parameter are mapped to different codewords.

Table 13 shows a mapping relationship from a transmission layer to a codeword, but the present application is not limited thereto.

TABLE 13

| Number of | Number of | Codeword-to-layer mapping |
|---|---|---|
| layers | codewords | i = 0, 1, . . . , M_{symb}^{layer} − 1 |
| 2 (1 + 1) | 2 | x ⁽⁰⁾ (i) = d⁽⁰⁾ (i) |
| | | x ⁽¹⁾ (i) = d⁽¹⁾ (i) |
| 3 | 2 | x ⁽⁰⁾ (i) = d⁽⁰⁾ (i) |
| (1 + 2, 2 + 1) | | x ⁽¹⁾ (i) = d⁽¹⁾ (2i) |
| | | x ⁽²⁾ (i) = d⁽¹⁾ (2i + 1) |
| | | x ⁽⁰⁾ (i) = d⁽⁰⁾ (2i) |
| | | x ⁽¹⁾ (i) = d⁽⁰⁾ (2i + 1) |
| | | x ⁽²⁾ (i) = d⁽¹⁾ (i) |
| 4 | 2 | x ⁽⁰⁾ (i) = d⁽⁰⁾ (2i) |
| (2 + 2, 1 + 3, 3 + 1) | | x ⁽¹⁾ (i) = d⁽⁰⁾ (2i + 1) |
| | | x ⁽²⁾ (i) = d⁽¹⁾ (2i) |
| | | x ⁽³⁾ (i) = d⁽¹⁾ (2i + 1) |
| | | x ⁽⁰⁾ (i) = d⁽⁰⁾ (i) |
| | | x ⁽¹⁾ (i) = d⁽¹⁾ (3i) |
| | | x ⁽²⁾ (i) = d⁽¹⁾ (3i + 1) |
| | | x ⁽³⁾ (i) = d⁽¹⁾ (3i + 2) |
| | | x ⁽⁰⁾ (i) = d⁽⁰⁾ (3i) |
| | | x ⁽¹⁾ (i) = d⁽⁰⁾ (3i + 1) |
| | | x ⁽²⁾ (i) = d⁽⁰⁾ (3i + 2) |
| | | x ⁽³⁾ (i) = d⁽¹⁾ (i) |

Embodiment 4: the DMRS port information of the plurality of uplink information is determined by one antenna port indication information.

In some embodiments, the target antenna port indication information includes fifth antenna port indication information, and the port information of the first DMRS and the port information of the second DMRS are determined according to the fifth antenna port indication information.

In some embodiments, the fifth antenna port indication information corresponds to an antenna port field in DCI.

Therefore, in this embodiment 4, there is no need to add an additional field in the DCI. Instead, the DMRS port information of the plurality of uplink information is determined by re-interpreting the antenna port field in the DCI, which is beneficial to reducing the DCI overhead.

In this embodiment 4, layer number information corresponding to the fifth antenna port indication information is a larger number of layers among the first number of layers and the second number of layers, i.e., when the port information of the first DMRS and the port information of the second DMRS are determined according to the fifth antenna port indication information, a correspondence corresponding to the larger number of layers among the first number of layers and the second number of layers is used.

In some embodiments, if the first number of layers is the same as the second number of layers, the port information of the first DMRS is the same as the port information of the second DMRS.

In some embodiments, if the first number of layers is different from the second number of layers, the port information of the DMRS corresponding to a smaller number of layers among the first number of layers and the second number of layers is a subset of the port information of the DMRS corresponding to the larger number of layers.

For example, if the first number of layers is greater than the second number of layers, the port of the second DMRS is a subset of the port of the first DMRS.

Exemplarily, the first number of layers is 1, the second number of layers is 2, and if the port of the second DMRS includes ports 0 and 1, then the port of the first DMRS includes port 0 or port 1.

It should be understood that in the embodiments of the present application, the port information of the DMRS corresponding to the smaller number of layers may refer to the port information of the DMRS of the uplink information associated with the smaller number of layers. Similarly, the port information of the DMRS corresponding to the larger number of layers may refer to the port information of the DMRS of the uplink information associated with the larger number of layers.

In some embodiments, the port information of the DMRS corresponding to the smaller number of layers among the first number of layers and the second number of layers being a subset of the port information of the DMRS corresponding to the larger number of layers, includes:
ports of the DMRS corresponding to the smaller number of layers include first n ports of the DMRS with smallest port indices among ports of the DMRS corresponding to the larger number of layers, where n is the smaller number of layers.

For example, the first number of layers is 1, the second number of layers is 2, the port of the first DMRS is a subset of the port of the second DMRS, and if the indices of the ports of the second DMRS are 0 and 1, the index of the port of the first DMRS is 0.

For another example, the first number of layers is 3, the second number of layers is 1, and if the indices of the ports of the first DMRS are 0, 1, 4, the index of the port of the second DMRS is 0.

In some embodiments, determining, by the terminal device, the port information of the first DMRS and the port information of the second DMRS according to the fifth antenna port indication information, includes:
determining the port information of the first DMRS and the port information of the second DMRS according to the fifth antenna port indication information and a target number of layers, where the target number of layers is a larger number of layers among a first number of layers and a second number of layers.

For example, a fourth correspondence among the plurality of correspondences is determined according to the target number of layers, where the plurality of correspondences correspond to different numbers of transmission layers, respectively, the fourth correspondence corresponds to the target number of layers, and fourth correspondence includes a correspondence between a state value of antenna port indication information and port information of a DMRS.

Further, the port information of the first DMRS and the port information of the second DMRS are determined according to the fifth antenna port indication information and the fourth correspondence.

It should be understood that the present application does not limit the representation manner of the fourth correspondence. For example, the fourth correspondence may be represented by a table, or may also be represented by a sentence, a text or a code, which is not limited to the present application.

Manner A: The fourth correspondence only includes the port information of the DMRS corresponding to the larger number of layers. The port information of the DMRS corresponding to the larger number of layers may be determined in the fourth correspondence according to the state value of the fifth antenna port indication information, and the port information of the DMRS corresponding to the smaller number of layers is a subset of the port information of the DMRS corresponding to the larger number of layers.

Case 1: If the larger number of layers is the first number of layers, the port information of the DMRS corresponding to the larger number of layers is determined as the port information of the first DMRS, and a subset of the port information of the DMRS corresponding to the larger number of layers is determined as the port information of the second DMRS. For example, first X DMRS ports with the smallest port indices among the ports of the first DMRS are used as the ports of the second DMRS, where X is the second number of layers.

Case 2: If the larger number of layers is the second number of layers, the port information of the DMRS corresponding to the larger number of layers is determined as the port information of the second DMRS, and a subset of the port information of the DMRS corresponding to the larger number of layers is determined as the port information of the first DMRS. For example, first Y DMRS ports with the smallest port indices among the ports of the second DMRS are used as the ports of the first DMRS, where Y is the first number of layers.

It is explained by taking an example in which the fourth correspondence is represented by a table. If the first number of layers is 1 and the second number of layers is 2, the layer number information corresponding to the fifth antenna port indication information is determined according to the second number of layers, and the port information of the second DMRS may be determined according to a table corresponding to the number of layers of 2. Table 14 is an example of a table corresponding to the number of layers of 2, but the present application is not limited thereto.

If the state value of the fifth antenna port indication information is 1, it may be determined that the port of the second DMRS includes ports 0 and 1 according to Table 14. Further, it may be determined that the port of the first DMRS includes the port 0 according to the fact that the port of the first DMRS is a subset of the port of the second DMRS.

TABLE 14

| | | DMRS port |
|---|---|---|
| State | Number of DMRS CDM | (Rank = 2, i.e., the |
| value | group(s) without data | number of layers is 2) |
| 0 | 1 | 0, 1 |
| 1 | 2 | 0, 1 |
| 2 | 2 | 2, 3 |
| 3 | 2 | 0, 2 |

Manner B: both the port information of the DMRS corresponding to the larger number of layers and the port information of the DMRS corresponding to the smaller number of layers are indicated by the fifth antenna port indication information. For example, they are indicated by a codepoint in the fifth antenna port indication information.

In some embodiments, the fourth correspondence includes the port information of the DMRS corresponding to the larger number of layers and the port information of the DMRS corresponding to the smaller number of layers. Then, the port information of the DMRS corresponding to the larger number of layers and the port information of the DMRS corresponding to the smaller number of layers may be determined in the fourth correspondence according to the state value of the fifth antenna port indication information.

That is, both the port information of the DMRS corresponding to the larger number of layers and the port information of the DMRS corresponding to the smaller number of layers may be determined by looking up the table.

Optionally, in the fourth correspondence, based on a same state value, the port information of the DMRS corresponding to the smaller number of layers is a subset of the port information of the DMRS corresponding to the larger number of layers.

Optionally, in this manner B, the layer number information corresponding to the fifth antenna port indication information may be considered to be a combination of the larger number of layers and the smaller number of layers.

Optionally, there may be a plurality of fourth correspondences, corresponding to different layer number combinations of the larger number of layers and the smaller number of layers, respectively.

For example, the fourth correspondence corresponding to the layer number combination may include 2+1 (where the first number of layers may be 2 or the second number of layers may be 2), 3+2 (where the first number of layers may be 3 or the second number of layers may be 3), 3+1 (where the first number of layers may be 3 or the second number of layers may be 3), etc.

It is explained by taking an example in which the fourth correspondence is represented by a table.

Example 1: If the first number of layers is 1 and the second number of layers is 2, the layer number information corresponding to the fifth antenna port indication information is determined according to the second number of layers, and the port information of the second DMRS and the port information of the first DMRS may be determined according to a table corresponding to the number of layers of 2. Table 15 is an example of a table corresponding to the number of layers of 2, but the present application is not limited thereto.

TABLE 15

| | Number of DMRS CDM | DMRS port | DMRS port |
|---|---|---|---|
| State value | group(s) without data | (rank = 2) | (rank = 1) |
| 0 | 1 | 0, 1 | 0 |
| 1 | 2 | 0, 1 | 0 |
| 2 | 2 | 2, 3 | 2 |
| 3 | 2 | 0, 2 | 0 |
| 4 | 1 | 0 ,1 | 1 |
| 5 | 2 | 0, 1 | 1 |
| 6 | 2 | 2, 3 | 3 |
| 7 | 2 | 0, 2 | 2 |

If the state value of the fifth antenna port indication information is 1, it may be determined that the port of the second DMRS includes port 0 and port 1, and the port of the first DMRS includes port 0.

Example 2: If the first number of layers is 3 and the second number of layers is 1, the layer number information corresponding to the fifth antenna port indication information is determined according to the first number of layers, and the port information of the second DMRS and the port information of the first DMRS may be determined according to a table corresponding to the number of layers of 3. Table 16 is an example of a table corresponding to the number of layers of 3, but the present application is not limited thereto.

TABLE 16

| | Number of DMRS CDM | DMRS port | DMRS port |
|---|---|---|---|
| State value | group(s) without data | (rank = 3) | (rank = 1) |
| 0 | 2 | 0, 1, 4 | 0 |
| 1 | 2 | 0, 1, 4 | 1 |
| 2 | 2 | 0, 1, 4 | 4 |
| 3-7 | Reserved | Reserved | Reserved |

If the state value of the fifth antenna port indication information is 1, it may be determined that the port of the first DMRS includes ports 0, 1, 4, and the port of the second DMRS includes port 1.

In some embodiments, if the sum of the first number of layers and the second number of layers does not exceed 8, when the larger number of layers is 3, the smaller number of layers may be 1 or 2. In this case, a table corresponding to the number of layers of 3 may be as shown in Table 17.

TABLE 17

| | Number of DMRS CDM | DMRS port | DMRS port |
|---|---|---|---|
| State value | group(s) without data | (rank = 3) | (rank < 3) |
| 0 | 2 | 0, 1, 4 | 0 |
| 1 | 2 | 0, 1, 4 | 1 |
| 2 | 2 | 0, 1, 4 | 4 |
| 3 | 2 | 0, 1, 4 | 0, 1 |
| 4 | 2 | 0, 1, 4 | 0, 4 |
| 5 | 2 | 0, 1, 4 | 1, 4 |
| 6-7 | Reserved | Reserved | Reserved |

If the second number of layers is 3, the first number of layers is 2, and the state value of the fifth antenna port indication information is 3, it may be determined that the port of the second DMRS includes ports 0, 1, and 4, and the port of the first DMRS includes ports 0 and 1.

Optionally, in some embodiments, Table 17 may also be differentiated into two tables, corresponding to a layer number combination 3+1 and a layer number combination 3+2, respectively.

In some embodiments, if the sum of the first number of layers and the second number of layers may exceed 4, for example, up to 8 layers are supported, then when the larger number of layers is 4, the smaller number of layers may be 1, 2 or 3. In this case, a table corresponding to the number of layers of 4 may be as shown in Table 18.

TABLE 18

| | Number of DMRS CDM | DMRS port | DMRS port |
|---|---|---|---|
| State value | group(s) without data | (rank = 4) | (rank < 4) |
| 0 | 2 | 0-3 | 0 |
| 1 | 2 | 0-3 | 1 |
| 2 | 2 | 0-3 | 2 |
| 3 | 2 | 0-3 | 3 |
| 4 | 2 | 0-3 | 0, 1 |
| 5 | 2 | 0-3 | 2, 3 |
| 6 | 2 | 0-3 | 0, 2 |
| 7 | 2 | 0-3 | 1, 3 |
| 8 | 2 | 0-3 | 1, 2 |
| 9 | 2 | 0-3 | 0, 3 |
| 10 | 2 | 0-3 | 0, 1, 2 |
| 11 | 2 | 0-3 | 0, 1, 3 |
| 12 | 2 | 0-3 | 0, 2, 3 |
| 13 | 2 | 0-3 | 1, 2, 3 |
| 14-15 | Reserved | Reserved | Reserved |

If the second number of layers is 4, the first number of layers is 3, and the state value of the fifth antenna port indication information is 10, it may be determined that the port of the second DMRS includes ports 0 to 3, and the port of the first DMRS includes ports 0 to 2.

Optionally, in some embodiments, Table 18 may be differentiated into three tables, corresponding to a layer number combination 4+3, a layer number combination 4+2, and a layer number combination 4+1, respectively.

It should be noted that the correspondence in the table shown in the present application is only an example. In actual applications, the contents in the table may also be deleted, modified or added. For example, all the correspondences in the table may be included, or only a part of the correspondences in the table may be included, for example, only the correspondences of some rows may be included, or some columns or cells may be deleted, or the information in some rows or cells in the table may also be adjusted, such as, by adjusting the correspondence between the state value and the DMRS port index (for example, in Table 18, the DMRS port indices corresponding to the state value 5 and the state value 6 may be exchanged, or, in Table 11, the DMRS port corresponding to the state value 1 may be 0, 1, 3), or, a new correspondence may be added to the table, for example, when more number of layers or more layer number combinations are supported, the table may also include the DMRS port information based on the corresponding number of layers or layer number combinations, or, tables corresponding to more number of layers or more layer number combinations are added.

Therefore, in the embodiments of the present application, when the plurality of uplink information is transmitted by the FDM transmission scheme, and the number of transmission layers of the first uplink information and the number of transmission layers of the second uplink information are allowed to be different, the DMRS ports of the two uplink information may be indicated by one antenna port field, without increasing the DCI overhead.

It should be understood that the embodiments of the present application are not limited to the transmission schemes of the plurality of uplink information applied in the above Embodiment 1 to Embodiment 4. For example, the transmission scheme such as the SDM, the FDM or the SFN, may be applied, or other transmission schemes introduced in the standard evolution may also be applied, which are not limited to the present application.

As an example but not a limitation, Embodiment 4 may be applicable to a scenario where the plurality of uplink information is transmitted by the FDM transmission scheme or SFN transmission scheme, for example.

As an example but not a limitation, Embodiment 1 to Embodiment 3 may be applicable to a scenario where the plurality of uplink information is transmitted by the SDM transmission scheme.

As an example but not a limitation, the terminal device determines to adopt any one of the methods of Embodiment 1 to Embodiment 4 according to the transmission scheme supported by the terminal device. For example, the terminal device supports the SDM scheme 1 of the SDM transmission scheme, and the terminal device determines to adopt any one of the methods of Embodiment 1 to Embodiment 3. For example, the terminal device supports the FDM transmission scheme or SFN transmission scheme, and determines to adopt the method of Embodiment 4.

As an example but not a limitation, the terminal device determines to adopt any one of the methods of Embodiment 1 to Embodiment 4 according to the transmission scheme configured or indicated by the network device. For example, the network device configures the transmission scheme to be the SDM transmission scheme, and the terminal device determines to adopt any one of the methods in Embodiment 1 to Embodiment 3. For example, the network device configures the transmission scheme to be the FDM transmission scheme or SFN transmission scheme, and the terminal device determines to adopt the method of Embodiment 4.

As an example but not a limitation, different transmission schemes of the plurality of uplink information may correspond to different implementations in Embodiment 1 to Embodiment 4, respectively. For example, the implementation of determining the port information of the DMRS and/or the number of transmission layers of the plurality of uplink information under different transmission schemes may be configured or predefined by the network device.

The manner for determining the port information of the DMRS and/or the number of transmission layers corresponding to the plurality of uplink information is explained above, in conjunction with Embodiment 1 to Embodiment 4. The manner for determining the number of PT-RS ports corresponding to the plurality of uplink information, and the association relationship between the PT-RS port and the DMRS port is explained below, in conjunction with some embodiments.

In some embodiments of the present application, the method further includes:
determining the number of the PT-RS ports used to transmit the plurality of uplink information according to first information, where the first information includes at least one of:
a number of spatial parameters associated with the plurality of uplink information;
a transmission mode used for simultaneously transmitting the plurality of uplink information;
a number of DMRS CDM groups corresponding to the port information of the DMRS of the plurality of uplink information;
a number of transmission layers of the plurality of uplink information;
a precoding matrix of the plurality of uplink information; or
a maximum number of PT-RS ports corresponding to the plurality of uplink information.

In some embodiments, the PT-RSs corresponding to the plurality of uplink information may mean that the PT-RSs are used for phase tracking of the plurality of uplink information, where each uplink information corresponds to one PT-RS.

In some embodiments, when the plurality of uplink information only includes the first uplink information and the second uplink information, the number of spatial parameters associated with the plurality of uplink information may be 2. For example, the number of PT-RS ports corresponding to the plurality of uplink information is determined according to the number of spatial parameters. As an example, if the number of spatial parameters is 2, the number of PT-RS ports corresponding to the plurality of uplink information is 2. As another example, if the number of spatial parameters is 1, the number of PT-RS ports corresponding to the plurality of uplink information is 1.

In some embodiments, the transmission scheme used for simultaneously transmitting the plurality of uplink information may include at least one of:
an FDM, an SDM, an SFN, or a TDM.

For example, when the transmission scheme of the plurality of uplink information is the FDM transmission scheme, the number of PT-RS ports is 1. For example, when the transmission scheme of the plurality of uplink information is the SDM transmission scheme, the number of PT-RS ports is 2. For example, when the transmission scheme of the plurality of uplink information is the SFN transmission scheme, the number of PT-RS ports is 1. For example, when the transmission scheme of the plurality of uplink information is the TDM transmission scheme, the number of PT-RS ports is 1. Therefore, in the embodiments of the present application, for different transmission schemes of the plurality of uplink information, the corresponding number of PT-RS ports may be used.

In some embodiments, the number of DMRS CDM groups corresponding to the port information of the DMRS of the plurality of uplink information may be 2 or 3, etc. For example, the number of PT-RS ports corresponding to the plurality of uplink information is determined according to the number of DMRS CDM groups. For example, if the number of DMRS CDM groups corresponding to the port information of the DMRS of the first uplink information and the second uplink information is 2, the number of PT-RS ports is 2.

In some embodiments, in a case where the sum of the first number of layers and the second number of layers does not exceed 4, the number of transmission layers of the plurality of uplink information may be any one of the above six layer number combinations.

In some embodiments, the number of PT-RS ports corresponding to the plurality of uplink information is determined according to the first number of layers and/or the second number of layers. For example, when the first number of layers is less than or equal to 2 layers, and/or the second number of layers is less than or equal to 2 layers, the number of PT-RS ports is 1. For another example, when the first number of layers is greater than 2, and/or the second number of layers is greater than 2, the number of PT-RS ports is greater than or equal to 2.

In some embodiments, the number of PT-RS ports corresponding to the plurality of uplink information is determined according to the precoding matrix of the plurality of uplink information.

In some embodiments, a maximum number of PT-RS ports corresponding to the plurality of uplink information may be m, where m is a positive integer, for example, 1 or 2.

The above embodiments may be combined with each other, which is not limited herein. For example, the number of PT-RS ports is determined according to the transmission scheme used for simultaneously transmitting the plurality of uplink information and the number of transmission layers of the plurality of uplink information. For another example, when the transmission scheme of the plurality of uplink information is the FDM transmission scheme, and the first number of layers is less than or equal to 2, and/or the second number of layers is less than or equal to 2, the number of PT-RS ports corresponding to the plurality of uplink information is 1. For example, in the FDM transmission scheme, the first number of layers is greater than 2, and/or the second number of layers is greater than 2, then the number of PT-RS ports corresponding to the plurality of uplink information is equal to 2.

Optionally, the maximum number of PT-RS ports corresponding to the plurality of uplink information may be configured by the network device. For example, it is determined according to PT-RS related configuration information of the network device.

In some embodiments, the method 200 further includes:
determining DMRS ports associated with PT-RS ports corresponding to the plurality of uplink information according to a number of the PT-RS ports corresponding to the plurality of uplink information and port association indication information, where the port association indication information is used to indicate an association relationship between the PT-RS ports and the DMRS ports.

For example, the DMRS ports associated with the PT-RS ports corresponding to the plurality of uplink information are determined according to the number of the PT-RS ports corresponding to the plurality of uplink information, the transmission mode used for simultaneously transmitting the plurality of uplink information and the port association indication information.

In some embodiments, the network device may also determine the number of the PT-RS ports corresponding to the plurality of uplink information, for example, according to the first information. For the determination manner, please refer to the relevant description on the terminal device side, which will not be repeated here.

In some embodiments, the network device may determine the DMRS ports associated with the PT-RS ports corresponding to the plurality of uplink information, and further indicate the information to the terminal device, for example, by the port association indication information.

In some embodiments, the port association indication information may be indicated by DCI.

In some embodiments, the port association indication information corresponds to a PTRS-DMRS association field in the DCI.

In some embodiments, the port association indication information includes first port association indication information and second port association indication information, the first port association indication information is associated with the first spatial parameter or the first uplink information, and the second port association indication information is associated with the second spatial parameter or the second uplink information. The first port association indication information is used to indicate the DMRS port associated with the PT-RS port corresponding to the first uplink information, and the second port association indication information is used to indicate the DMRS port associated with the PT-RS port corresponding to the second uplink information.

In some embodiments, the terminal device determines the number (for example, a first number) of PT-RS ports corresponding to the plurality of uplink information according to the first information, and then determines the DMRS port associated with the PT-RS port according to the port association indication information in conjunction with a first association relationship, the first association relationship is an association relationship between the PT-RS port and the DMRS port when the number of PT-RS ports is the first number. For example, the DMRS port associated with the PT-RS port is determined according to the state value of the port association indication information in conjunction with the first association relationship. In some embodiments, when the terminal device determines the DMRS port associated with the PT-RS port according to the port association indication information, the terminal device needs to combine, in addition to the number of PT-RS ports, in some cases, the number of transmission layers of the first uplink information and/or the uplink information.

In some embodiments, if the number of PT-RS ports corresponding to the plurality of uplink information is 2, including a PT-RS port 0 and a PT-RS port 1, and the number of transmission layers of the first uplink information and the second uplink information does not exceed 2, the state value of the port association indication information is used to indicate DMRS ports associated with the PT-RS port 0 and the PT-RS port 1 respectively.

Optionally, the port association indication information may be 2 bits, corresponding to the PT-RS port 0 and the PT-RS port 1, respectively, and the 1-bit state value of each PT-RS port is used to indicate a DMRS port associated with the PT-RS port.

In some embodiments, the DMRS ports associated with the PT-RS port 0 and the PT-RS port 1 are determined according to the port association indication information and the first association relationship. Herein, the first association relationship is an association relationship between a PT-RS port and a DMRS port when the number of PT-RS ports is 2.

In some embodiments, in the first association relationship, the PT-RS port 0 is associated with a first target DMRS port or a second target DMRS port, where the first target DMRS port is a first DMRS port associated with a first spatial parameter, the second target DMRS port is a second DMRS port associated with the first spatial parameter, and the first spatial parameter is associated with the first uplink information.

For example, when the 1-bit state value corresponding to the PT-RS port 0 is 0, the PT-RS port 0 is associated with the first target DMRS port, otherwise it is associated with the second target DMRS port.

In some embodiments, in the first association relationship, the PT-RS port 1 is associated with a third target DMRS port or a fourth target DMRS port, where the third target DMRS port is a first DMRS port associated with a second spatial parameter, the fourth target DMRS port is a second DMRS port associated with the second spatial parameter, and the second spatial parameter is associated with the second uplink information.

For example, when the 1-bit state value corresponding to the PT-RS port 1 is 0, the PT-RS port 1 is associated with the third target DMRS port, otherwise it is associated with the fourth target DMRS port.

In another embodiment, if the number of the PT-RS ports corresponding to the plurality of uplink information is 2, a number of transmission layers of the first uplink information or the second uplink information is 3, a state value of the port association indication information is used to indicate a DMRS port associated with a first PT-RS port respectively, and the first PT-RS port is a PT-RS port of the uplink information with the number of transmission layers equal to 3 among the first uplink information and the second uplink information. It should be understood that in this embodiment, the sum of the number of transmission layers of the first uplink information and the second uplink information does not exceed 4, when the number of transmission layers of one of the uplink information is 3, the number of transmission layers of another of the uplink information is 1. Therefore, it is not necessary to indicate the DMRS port associated with the PT-RS port of this uplink information. Instead, it is only necessary to indicate the DMRS port associated with the PT-RS port of the uplink information with the number of the transmission layers of 3.

Optionally, the port association information may be 2 bits, corresponding to a first PT-RS port. The first PT-RS port is the PT-RS port of the uplink information with a number of transmission layers of 3. The 2-bit state value is used to indicate the DMRS port associated with the first PT-RS port.

In some embodiments, the DMRS port associated with the first PT-RS port is determined according to the port association indication information and a second association relationship.

In some embodiments, in the second association relationship, different state values of the port association indication information are used to indicate a target DMRS port associated with the first PT-RS port, where the target DMRS port is associated with a target spatial parameter, and the target spatial parameter is associated with the uplink information with the number of transmission layers equal to 3 among the first uplink information and the second uplink information.

In some embodiments, the state value of the port association indication information is used to indicate at least one of following DMRS ports:
a first DMRS port associated with the target spatial parameter;
a second DMRS port associated with the target spatial parameter;
a third DMRS port associated with the target spatial parameter; or
a fourth DMRS port associated with the target spatial parameter.

For example, when the state value of the port association indication information is 0, the first PT-RS port is associated with the first DMRS port associated with the target spatial parameter; when the state value of the port association indication information is 1, the first PT-RS port is associated with the second DMRS port associated with the target spatial parameter; when the state value of the port association indication information is 2, the first PT-RS port is associated with the third DMRS port associated with the target spatial parameter; when the state value of the port association indication information is 3, the first PT-RS port is associated with the fourth DMRS port associated with the target spatial parameter.

In the following, it is explained by taking an example in which the spatial parameter is a TCI state.

Example 1: The number of PT-RS ports is determined according to the transmission scheme for simultaneously transmitting the plurality of the uplink information and/or the number of TCI states.

For example, when the SDM transmission scheme is used for simultaneously transmitting the plurality of uplink information, the number of PT-RS ports is determined to be 2.

For another example, when the number of spatial parameters associated with the plurality of uplink information is 2, the number of PT-RS ports is determined to be 2.

For yet another example, when the SDM transmission scheme is used for simultaneously transmitting the plurality of uplink information, and the number of spatial parameters associated with the plurality of uplink information is 2, the number of PT-RS ports is determined to be 2.

Furthermore, in conjunction with Case 1 and Case 2, the mapping manner of the PT-RS port and the DMRS port when the number of PT-RS ports is 2 is explained.

Case 1: The number of PT-RS ports is 2, and the combination of the first number of layers and the second number of layers is the aforementioned first layer number combination, second layer number combination, third layer number combination and fourth layer number combination.

The port association indication information is 2 bits, corresponding to a PT-RS port 0 and a PT-RS port 1, respectively. For example, the high bit of the 2 bits is associated with the PT-RS port 0, and the low bit of the 2 bits is associated with the PT-RS port 1. Two states of the high bit indicate the DMRS ports associated with the first TCI state, respectively. Two states of the low bits indicate the DMRS ports associated with the second TCI state, respectively. Table 19 shows an association relationship between the PT-RS port and the DMRS port.

TABLE 19

| State | | | |
|---|---|---|---|
| value of | | State value | |
| the high | DMRS port associated | of the low | DMRS port associated |
| bit | with the PT-RS port 0 | bit | with the PT-RS port 1 |
| 0 | First DMRS port | 0 | First DMRS port |
| | associated with the | | associated with |
| | first TCI state | | the second TCI state |
| 1 | Second DMRS port | 1 | Second DMRS port |
| | associated with the | | associated with the |
| | first TCI state | | second TCI state |

When the 2-bit state value of the port association indication information is 11, it may be determined that the PT-RS port 0 is associated with the second DMRS port associated with the first TCI state, and the PT-RS port 1 is associated with the second DMRS port associated with the second TCI state.

Case 2: The number of PT-RS ports is 2, and the combination of the first number of layers and the second number of layers is the aforementioned fifth layer number combination or sixth layer number combination.

The port association indication information is 2 bits, which are used to indicate the DMRS port associated with the PT-RS port of the uplink information with the number of layers of 3. The association relationship between the DMRS port and the PT-RS port of the uplink information with the number of layers of 1 does not need to be indicated. Table 20 shows an association relationship between the PT-RS port and the DMRS port in this case.

TABLE 20

| State value | DMRS port |
|---|---|
| 0 | First DMRS port associated with a specific TCI state |
| 1 | Second DMRS port associated with a specific TCI state |
| 2 | Third DMRS port associated with a specific TCI state |
| 3 | Fourth DMRS port associated with a specific TCI state |

It should be understood that in Table 20, the specific TCI state is a TCI state associated with the uplink information with the number of layers of 3.

Example 2: the number of PT-RS ports is determined according to the transmission scheme for simultaneously transmitting the plurality of the uplink information and/or the number of TCI states.

For example, when the FDM transmission scheme or SFN transmission scheme is used for simultaneously transmitting the plurality of uplink information, the number of PT-RS ports is determined to be 2.

For another example, when the number of spatial parameters associated with the plurality of uplink information is 2, the number of PT-RS ports is determined to be 2.

For yet another example, when the FDM transmission scheme or SFN transmission scheme is used for simultaneously transmitting the plurality of uplink information, and the number of spatial parameters associated with the plurality of uplink information is 2, the number of PT-RS ports is determined to be 2.

Furthermore, in conjunction with Case 1 and Case 2, the mapping manner of the PT-RS port and the DMRS port when the number of PT-RS ports is 2 is explained.

Case 1: the number of PT-RS ports is 2. For the FDM transmission scheme, the combination of the first number of layers and the second number of layers is the aforementioned first layer number combination, second layer number combination, third layer number combination and fourth layer number combination. For the SFN transmission scheme, the combination of the first number of layers and the second number of layers is the case of the first layer number combination and the fourth layer number combination. In this case, the manner of determining the association relationship between the PT-RS port and the DMRS port is the same as that in Case 1 in Example 1, which will not be repeated herein.

Case 2: the number of PT-RS ports is 1.

In some embodiments, each uplink information of the plurality of uplink information is associated with at least one transmission layer of the target uplink information. When the number of PT-RS ports is 1, the terminal device expects that a DMRS port associated with a PT-RS port corresponding to the plurality of uplink information is used to transmit a transmission layer with a best quality in the target uplink information.

In other words, the terminal device expects that the DMRS port associated with the PT-RS is the transmission layer with the best quality for the first uplink transmission associated with the first TCI state and the second uplink transmission associated with the second TCI state.

Therefore, in the embodiments of the present application, for different transmission schemes of the plurality of uplink information, different mapping schemes may be used for the PT-RS port and the DMRS port, which is beneficial to ensure that the PT-RS port is associated with the transmission layer with the best quality.

In summary, the embodiments of the present application provide the scheme for determining the DMRS port and the number of transmission layers in the scenario where the plurality of uplink information is transmitted simultaneously. The terminal device may determine the DMRS port and the transmission layer number information of the plurality of uplink information according to the target antenna port indication information, and further, perform the simultaneous transmission of the plurality of uplink information according to the DMRS port and the transmission layer number information of the plurality of uplink information, which is beneficial to improving the transmission performance.

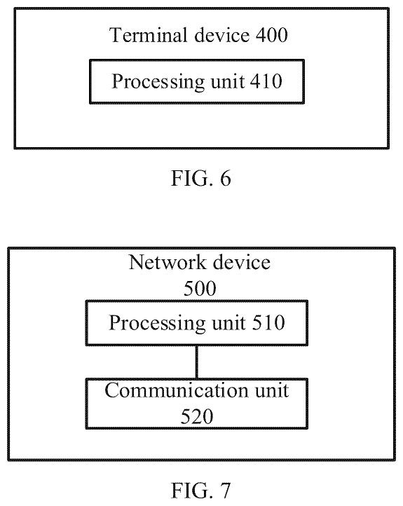

The method embodiments of the present application are described in detail above with reference to FIG. 3 to FIG. 5, and apparatus embodiments of the present application are described in detail below with reference to FIG. 6 to FIG. 10, and it should be understood that the apparatus embodiments and the method embodiments correspond to each other, and the similar description may refer to the method embodiments.

FIG. 6 shows a schematic block diagram of a terminal device 400, according to the embodiments of the present application. As shown in FIG. 6, the terminal device 400 includes:
a processing unit 410, configured to determine port information of a demodulation reference signal (DMRS) and/or transmission layer number information of a plurality of uplink information according to target antenna port indication information, where the plurality of uplink information is associated with different spatial parameters, and the plurality of uplink information includes first uplink information and second uplink information.

In some embodiments, the target antenna port indication information includes first antenna port indication information and second antenna port indication information; the processing unit 410 is further configured to:
determine port information of a first DMRS according to the first antenna port indication information and determine port information of a second DMRS according to the second antenna port indication information;
where the first DMRS is associated with the first uplink information, and the second DMRS is associated with the second uplink information.

In some embodiments, the processing unit 410 is further configured to:
determine the port information of the first DMRS according to the first antenna port indication information and a first transmission parameter, and determine the port information of the second DMRS according to the second antenna port indication information and a second transmission parameter;
where the first transmission parameter is associated with the first uplink information, and the second transmission parameter is associated with the second uplink information.

In some embodiments, the first transmission parameter includes at least one of:
a first number of layers, a type of the first DMRS, a maximum number of symbols of the first DMRS, or a number of DMRS code division multiplexing (CDM) groups.

The second transmission parameter includes at least one of:
a second number of layers, a type of the second DMRS, a maximum number of symbols of the second DMRS, or a number of DMRS CDM groups.

In some embodiments, the processing unit 410 is further configured to:
determine a first correspondence in a plurality of correspondences according to the first number of layers, where the plurality of correspondences correspond to different numbers of transmission layers, respectively, the first correspondence corresponds to the first number of layers, and the first correspondence includes a correspondence between a state value of antenna port indication information and port information of a DMRS;
determine the port information of the first DMRS according to the first antenna port indication information and the first correspondence.

In some embodiments, in a case where the first number of layers is 3, the type of the first DMRS is a type 1, and the maximum number of symbols of the first DMRS is 2, in the first correspondence, the state value of the antenna port indication information is used to indicate at least one of following DMRS ports:
DMRS ports 0, 1, 4; or
DMRS ports 2, 3, 6.

In some embodiments, in a case where the first number of layers is 3, the type of the first DMRS is a type 2, and the maximum number of symbols of the first DMRS is 2, in the first correspondence, the state value of the antenna port indication information is used to indicate at least one of following DMRS ports:
DMRS ports 0, 1, 6;
DMRS ports 2, 3, 8; or
DMRS ports 4, 5, 10.

In some embodiments, the processing unit 410 is further configured to:
determine a second correspondence in a plurality of correspondences according to the second transmission parameter, where the plurality of correspondences correspond to different numbers of transmission layers, respectively, the second correspondence corresponds to the second number of layers, and the second correspondence includes a correspondence between a state value of antenna port indication information and port information of a DMRS;
determine the port information of the second DMRS according to the second antenna port indication information and the second correspondence.

In some embodiments, in a case where the second number of layers is 3, the type of the second DMRS is a type 1, and the maximum number of symbols of the second DMRS is 2, in the second correspondence, the state value of the antenna port indication information is used to indicate at least one of following DMRS ports:
DMRS ports 0, 1, 4; or
DMRS ports 2, 3, 6.

In some embodiments, in a case where the second number of layers is 3, the type of the second DMRS is a type 2, and the maximum number of symbols of the second DMRS is 2, in the second correspondence, the state value of the antenna port indication information is used to indicate at least one of following DMRS ports:
DMRS ports 0, 1, 6;
DMRS ports 2, 3, 8; or
DMRS ports 4, 5, 10.

In some embodiments, a port of the first DMRS and a port of the second DMRS are in different DMRS CDM groups, where the first DMRS is associated with the first uplink information, and the second DMRS is associated with the second uplink information.

In some embodiments, the first transmission parameter is configured or indicated by a network device, and the second transmission parameter is configured or indicated by a network device.

In some embodiments, the target antenna port indication information includes third antenna port indication information, and the processing unit 410 is further configured to:
determine port information of a first DMRS, port information of a second DMRS, a first number of layers, and a second number of layers according to the third antenna port indication information;
where the first DMRS and the first number of layers are associated with the first uplink information, and the second DMRS and the second number of layers are associated with the second uplink information.

In some embodiments, the processing unit 410 is further configured to:
determine the port information of the first DMRS, the port information of the second DMRS, the first number of layers, and the second number of layers according to the third antenna port indication information and a third transmission parameter;
where the third transmission parameter includes a transmission parameter of the first uplink information and a transmission parameter of the second uplink information.

In some embodiments, the third transmission parameter includes at least one of:
a type of the first DMRS, a maximum number of symbols of the first DMRS, a type of the second DMRS, a maximum number of symbols of the second DMRS, or a number of DMRS CDM groups;
where the type of the first DMRS and the maximum number of symbols of the first DMRS are associated with the first uplink information, and the type of the second DMRS and the maximum number of symbols of the second DMRS are associated with the second uplink information.

In some embodiments, the third antenna port indication information is used to indicate at least one of following states:
the port information of the first DMRS, the port information of the second DMRS, a port of the first DMRS and a port of the second DMRS being in different CDM groups, and a first layer number combination: the first number of layers and the second number of layers being both 1;
the port information of the first DMRS, the port information of the second DMRS, the port of the first DMRS and the port of the second DMRS being in different CDM groups, and a second layer number combination: the first number of layers being 2 and the second number of layers being 1;
the port information of the first DMRS, the port information of the second DMRS, the port of the first DMRS and the port of the second DMRS being in different CDM groups, and a third layer number combination: the first number of layers being 1 and the second number of layers being 2;
the port information of the first DMRS, the port information of the second DMRS, the port of the first DMRS and the port of the second DMRS being in different CDM groups, and a fourth layer number combination: the first number of layers being 2 and the second number of layers being 2;
the port information of the first DMRS, the port information of the second DMRS, the port of the first DMRS and the port of the second DMRS being in different CDM groups, and a fifth layer number combination: the first number of layers being 1 and the second number of layers being 3; or the port information of the first DMRS, the port information of the second DMRS, the port of the first DMRS and the port of the second DMRS being in different CDM groups, and a sixth layer number combination: the first number of layers being 3 and the second number of layers being 1.

In some embodiments, the target antenna port indication information includes fourth antenna port indication information, and the processing unit 410 is further configured to: determine port information of a first DMRS and port information of a second DMRS according to the fourth antenna port indication information;
where the first DMRS is associated with the first uplink information, and the second DMRS is associated with the second uplink information.

In some embodiments, the processing unit 410 is further configured to:
determine the port information of the first DMRS and the port information of the second DMRS according to the fourth antenna port indication information and a fourth transmission parameter;
where the fourth transmission parameter includes a transmission parameter of the first uplink information and a transmission parameter of the second uplink information.

In some embodiments, the fourth transmission parameter includes at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
where the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.

In some embodiments, a port of the first DMRS and a port of the second DMRS are in different DMRS CDM groups, where the first DMRS is associated with the first uplink information, and the second DMRS is associated with the second uplink information.

In some embodiments, the processing unit 410 is further configured to:
determine a third correspondence in a plurality of correspondences according to a sum of the first number of layers and the second number of layers, where the plurality of correspondences correspond to different numbers of transmission layers, respectively, the third correspondence corresponds to the sum of the first number of layers and the second number of layers, and the third correspondence includes a correspondence between a state value of antenna port indication information, and port information of the first DMRS and port information of the second DMRS;
determine the port information of the first DMRS and the port information of the second DMRS according to the fourth antenna port indication information and the third correspondence.

In some embodiments, the first DMRS and the second DMRS are located on different symbols in time domain, where the first DMRS is associated with the first uplink information, and the second DMRS is associated with the second uplink information.

In some embodiments, the plurality of uplink information is transmitted by using a spatial division multiplexing (SDM) transmission scheme.

In some embodiments, the first uplink information is associated with a first spatial parameter, and the second uplink information is associated with a second spatial parameter, where the first uplink information and the second uplink information are different transmission layers of target uplink information, and a transmission layer associated with the first spatial parameter and a transmission layer associated with the second spatial parameter are mapped to different codewords.

In some embodiments, the target antenna port indication information includes fifth antenna port indication information, and the processing unit 410 is further configured to:
determine port information of a first DMRS and port information of a second DMRS according to the fifth antenna port indication information;
where the first DMRS is associated with the first uplink information, and the second DMRS is associated with the second uplink information.

In some embodiments, the processing unit 410 is further configured to:
determine the port information of the first DMRS and the port information of the second DMRS according to the fifth antenna port indication information and a target number of layers, where the target number of layers is a larger number of layers among a first number of layers and a second number of layers, the first number of layers is associated with the first uplink information, and the second number of layers is associated with the second uplink information.

In some embodiments, the processing unit 410 is further configured to:
determine a fourth correspondence in a plurality of correspondences according to the target number of layers, where the plurality of correspondences correspond to different numbers of transmission layers, respectively, the fourth correspondence corresponds to the target number of layers, and the fourth correspondence includes a correspondence between a state value of antenna port indication information and port information of a DMRS; and
determine the port information of the first DMRS and the port information of the second DMRS according to the fifth antenna port indication information and the fourth correspondence.

In some embodiments, the fourth correspondence includes port information of a DMRS corresponding to the target number of layers, where the processing unit 410 is further configured to:
determine the port information of the DMRS corresponding to the target number of layers, in the fourth correspondence according to a state value of the fifth antenna port indication information;
if the target number of layers is the first number of layers, determine the port information of the DMRS corresponding to the target number of layers as the port information of the first DMRS, and determine a subset of the port information of the DMRS corresponding to the target number of layers as the port information of the second DMRS; or
if the target number of layers is the second number of layers, determine the port information of the DMRS corresponding to the target number of layers as the port information of the second DMRS, and determine a subset of the port information of the DMRS corresponding to the target number of layers as the port information of the first DMRS.

In some embodiments, the fourth correspondence includes port information of a DMRS corresponding to the target number of layers, and port information of a DMRS corresponding to a smaller number of layers among the first number of layers and the second number of layers;
where the processing unit 410 is further configured to:
determine the port information of the DMRS corresponding to the target number of layers and the port information of the DMRS corresponding to the smaller number of layers among the first number of layers and the second number of layers, in the fourth correspondence according to a state value of the fifth antenna port indication information;
if the target number of layers is the first number of layers, determine the port information of the DMRS corresponding to the target number of layers as the port information of the first DMRS, and determine the port information of the DMRS corresponding to the smaller number of layers as the port information of the second DMRS; or
if the target number of layers is the second number of layers, determine the port information of the DMRS corresponding to the target number of layers as the port information of the second DMRS, and determine the port information of the DMRS corresponding to the smaller number of layers as the port information of the first DMRS.

In some embodiments, in the fourth correspondence, the port information of the DMRS corresponding to the smaller number of layers is a subset of the port information of the DMRS corresponding to the target number of layers.

In some embodiments, the port information of the DMRS corresponding to the smaller number of layers is indicated by a codepoint in the fifth antenna port indication information.

In some embodiments, if the first number of layers is the same as the second number of layers, the port information of the first DMRS is the same as the port information of the second DMRS; or if the first number of layers is different from the second number of layers, port information of a DMRS corresponding to a smaller number of layers among the first number of layers and the second number of layers is a subset of port information of a DMRS corresponding to a larger number of layers among the first number of layers and the second number of layers.

In some embodiments, the port information of the DMRS corresponding to the smaller number of layers among the first number of layers and the second number of layers being the subset of the port information of the DMRS corresponding to the larger number of layers, includes that:
ports of the DMRS corresponding to the smaller number of layers include first n ports of the DMRS with smallest port indices among ports of the DMRS corresponding to the larger number of layers, where n is the smaller number of layers.

In some embodiments, the target antenna port indication information is configured by downlink control information (DCI).

In some embodiments, the processing unit 410 is further configured to:
determine DMRS ports associated with PT-RS ports corresponding to the plurality of uplink information according to a number of the PT-RS ports corresponding to the plurality of uplink information and port association indication information, where the port association indication information is used to indicate an association relationship between the PT-RS ports and the DMRS ports.

In some embodiments, the number of PT-RS ports corresponding to the plurality of uplink information is determined according to first information, and the first information includes at least one of:
a number of spatial parameters associated with the plurality of uplink information;
a transmission mode used for simultaneously transmitting the plurality of uplink information;
a number of DMRS CDM groups corresponding to the port information of the DMRS of the plurality of uplink information;
a number of transmission layers of the plurality of uplink information;
a precoding matrix of the plurality of uplink information; or
a maximum number of PT-RS ports corresponding to the plurality of uplink information.

In some embodiments, if the number of the PT-RS ports corresponding to the plurality of uplink information is 2, including a PT-RS port 0 and a PT-RS port 1, a number of transmission layers of the first uplink information and the second uplink information does not exceed 2, a state value of the port association indication information is used to indicate DMRS ports associated with the PT-RS port 0 and the PT-RS port 1, respectively, and the DMRS ports associated with the PT-RS port 0 and the PT-RS port 1 is determined according to the port association indication information and a first association relationship;
in the first association relationship, the PT-RS port 0 is associated with a first target DMRS port or a second target DMRS port, where the first target DMRS port is a first DMRS port associated with a first spatial parameter, the second target DMRS port is a second DMRS port associated with the first spatial parameter, and the first spatial parameter is associated with the first uplink information;
in the first association relationship, the PT-RS port 1 is associated with a third target DMRS port or a fourth target DMRS port, where the third target DMRS port is a first DMRS port associated with a second spatial parameter, the fourth target DMRS port is a second DMRS port associated with the second spatial parameter, and the second spatial parameter is associated with the second uplink information.

In some embodiments, if the number of the PT-RS ports corresponding to the plurality of uplink information is 2, a number of transmission layers of the first uplink information or the second uplink information is 3, a state value of the port association indication information is used to indicate a DMRS port associated with a first PT-RS port respectively, and the first PT-RS port is a PT-RS port of the uplink information with the number of transmission layers equal to 3 among the first uplink information and the second uplink information, where the DMRS port associated with the first PT-RS port is determined according to the port association indication information and a second association relationship;
in the second association relationship, different state values of the port association indication information are used to indicate a target DMRS port associated with the first PT-RS port, where the target DMRS port is associated with a target spatial parameter, and the target spatial parameter is associated with the uplink information with the number of transmission layers equal to 3 among the first uplink information and the second uplink information.

In some embodiments, the state value of the port association indication information is used to indicate at least one of following DMRS ports:
a first DMRS port associated with the target spatial parameter;
a second DMRS port associated with the target spatial parameter;
a third DMRS port associated with the target spatial parameter; or
a fourth DMRS port associated with the target spatial parameter.

In some embodiments, each uplink information of the plurality of uplink information is associated with at least one transmission layer of target uplink information, and the terminal device expects that a DMRS port associated with a PT-RS port corresponding to the plurality of uplink information is used to transmit a transmission layer with a best quality in the target uplink information.

Optionally, in some embodiments, the above communication unit may be a communication interface or a transceiver, or an input and output interface of a communication chip or a system-on-chip. The above processing unit may be one or more processors.

It should be understood that the terminal device 400 according to the embodiments of the present application may correspond to the terminal device in the method embodiments of the present application, and the above and other operations and/or functions of various units in the terminal device 400 are respectively to implement the corresponding procedure of the terminal device of the method 200 shown in FIG. 3 to FIG. 5, which will not be repeated here for the sake of brevity.

FIG. 7 is a schematic block diagram of a network device according to the embodiments of the present application. The network device 500 of FIG. 7 includes:
a processing unit 510, configured to determine port information of a demodulation reference signal (DMRS) and/or transmission layer number information of a plurality of uplink information, where the plurality of uplink information is associated with different spatial parameters, and the plurality of uplink information includes first uplink information and second uplink information;
a communication unit 520, configured to transmit target antenna port indication information to a terminal device, where the target antenna port indication information is used by the terminal device to determine the port information of the DMRS and/or the transmission layer number information of the plurality of uplink information.

In some embodiments, the target antenna port indication information includes first antenna port indication information and second antenna port indication information, the first antenna port indication information is used to determine port information of a first DMRS, and the second antenna port indication information is used to determine port information of a second DMRS; where the first DMRS is associated with the first uplink information, and the second DMRS is associated with the second uplink information.

In some embodiments, the port information of the first DMRS is determined according to the first antenna port indication information and a first transmission parameter, and the port information of the second DMRS is determined according to the second antenna port indication information and a second transmission parameter, where the first transmission parameter is associated with the first uplink information, and the second transmission parameter is associated with the second uplink information.

In some embodiments, the first transmission parameter includes at least one of:
a first number of layers, a type of the first DMRS, a maximum number of symbols of the first DMRS, or a number of DMRS code division multiplexing (CDM) groups;
the second transmission parameter includes at least one of:
a second number of layers, a type of the second DMRS, a maximum number of symbols of the second DMRS, or a number of DMRS CDM groups.

In some embodiments, a port of the first DMRS and a port of the second DMRS are in different DMRS CDM groups, where the first DMRS is associated with the first uplink information, and the second DMRS is associated with the second uplink information.

In some embodiments, the target antenna port indication information includes third antenna port indication information, and the third antenna port indication information is used to determine port information of a first DMRS, port information of a second DMRS, a first number of layers, and a second number of layers;
where the first DMRS and the first number of layers are associated with the first uplink information, and the second DMRS and the second number of layers are associated with the second uplink information.

In some embodiments, the port information of the first DMRS, the port information of the second DMRS, the first number of layers and the second number of layers are determined according to the third antenna port indication information and a third transmission parameter, where the third transmission parameter includes a transmission parameter of the first uplink information and a transmission parameter of the second uplink information.

In some embodiments, the third transmission parameter includes at least one of:
a type of the first DMRS, a maximum number of symbols of the first DMRS, a type of the second DMRS, a maximum number of symbols of the second DMRS, or a number of DMRS CDM groups;
where the type of the first DMRS and the maximum number of symbols of the first DMRS are associated with the first uplink information, and the type of the second DMRS and the maximum number of symbols of the second DMRS are associated with the second uplink information.

In some embodiments, the third antenna port indication information is used to indicate at least one of following states:
the port information of the first DMRS, the port information of the second DMRS, a port of the first DMRS and a port of the second DMRS being in different CDM groups, and a first layer number combination: the first number of layers and the second number of layers being both 1;
the port information of the first DMRS, the port information of the second DMRS, the port of the first DMRS and the port of the second DMRS being in different CDM groups, and a second layer number combination: the first number of layers being 2 and the second number of layers being 1;
the port information of the first DMRS, the port information of the second DMRS, the port of the first DMRS and the port of the second DMRS being in different CDM groups, and a third layer number combination: the first number of layers being 1 and the second number of layers being 2;
the port information of the first DMRS, the port information of the second DMRS, the port of the first DMRS and the port of the second DMRS being in different CDM groups, and a fourth layer number combination: the first number of layers being 2 and the second number of layers being 2;
the port information of the first DMRS, the port information of the second DMRS, the port of the first DMRS and the port of the second DMRS being in different CDM groups, and a fifth layer number combination: the first number of layers being 1 and the second number of layers being 3; or
the port information of the first DMRS, the port information of the second DMRS, the port of the first DMRS and the port of the second DMRS being in different CDM groups, and a sixth layer number combination: the first number of layers being 3 and the second number of layers being 1.

In some embodiments, the target antenna port indication information includes fourth antenna port indication information, and the fourth antenna port indication information is used to determine port information of a first DMRS and port information of a second DMRS, where the first DMRS is associated with the first uplink information, and the second DMRS is associated with the second uplink information.

In some embodiments, the port information of the first DMRS and the port information of the second DMRS are determined according to the fourth antenna port indication information and a fourth transmission parameter, where the fourth transmission parameter includes a transmission parameter of the first uplink information and a transmission parameter of the second uplink information.

In some embodiments, the fourth transmission parameter includes at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
where the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.

In some embodiments, a port of the first DMRS and a port of the second DMRS are in different DMRS CDM groups, where the first DMRS is associated with the first uplink information, and the second DMRS is associated with the second uplink information.

In some embodiments, the first DMRS and the second DMRS are located on different symbols in time domain, where the first DMRS is associated with the first uplink information, and the second DMRS is associated with the second uplink information.

In some embodiments, the plurality of uplink information is transmitted by using a spatial division multiplexing (SDM) transmission scheme.

In some embodiments, the first uplink information is associated with a first spatial parameter, and the second uplink information is associated with a second spatial parameter, where the first uplink information and the second uplink information are different transmission layers of target uplink information, and a transmission layer associated with the first spatial parameter and a transmission layer associated with the second spatial parameter are mapped to different codewords.

In some embodiments, the target antenna port indication information includes fifth antenna port indication information, and the fifth antenna port indication information is used to determine port information of a first DMRS and port information of a second DMRS, where the first DMRS is associated with the first uplink information, and the second DMRS is associated with the second uplink information.

In some embodiments, layer number information corresponding to the fifth antenna port indication information is to indicate a larger number of layers among a first number of layers and a second number of layers, the first number of layers is associated with the first uplink information, and the second number of layers is associated with the second uplink information.

In some embodiments, if the first number of layers is the same as the second number of layers, the port information of the first DMRS is the same as the port information of the second DMRS; or if the first number of layers is different from the second number of layers, port information of a DMRS corresponding to a smaller number of layers among the first number of layers and the second number of layers is a subset of port information of a DMRS corresponding to a larger number of layers among the first number of layers and the second number of layers.

In some embodiments, the port information of the DMRS corresponding to the smaller number of layers among the first number of layers and the second number of layers being the subset of the port information of the DMRS corresponding to the larger number of layers, includes that:
ports of the DMRS corresponding to the smaller number of layers include first n ports of the DMRS with smallest port indices among ports of the DMRS corresponding to the larger number of layers, where n is the smaller number of layers.

In some embodiments, port information of a DMRS corresponding to a smaller number of layers among the first number of layers and the second number of layers is indicated by a codepoint in the fifth antenna port indication information.

In some embodiments, the plurality of uplink information is transmitted by using a frequency division multiplexing (FDM) transmission scheme or a single frequency network (SFN) transmission scheme.

In some embodiments, the target antenna port indication information is configured by downlink control information (DCI).

In some embodiments, the processing unit 510 is further configured to:
determine a number of PT-RS ports corresponding to the plurality of uplink information, and DMRS ports associated with the PT-RS ports corresponding to the plurality of uplink information;
the communication unit 520 is further configured to: transmit port association indication information to the terminal device, to indicate an association relationship between the PT-RS ports and the DMRS ports.

In some embodiments, the number of the PT-RS ports corresponding to the plurality of uplink information is determined according to first information, and the first information includes at least one of:
a number of spatial parameters associated with the plurality of uplink information;
a transmission mode used for simultaneously transmitting the plurality of uplink information;
a number of DMRS CDM groups corresponding to the port information of the DMRS of the plurality of uplink information;
a number of transmission layers of the plurality of uplink information;
a precoding matrix of the plurality of uplink information; or
a maximum number of PT-RS ports used to transmit the plurality of uplink information.

In some embodiments, each uplink information of the plurality of uplink information is associated with at least one transmission layer of target uplink information, and the terminal device expects that a DMRS port associated with a PT-RS port corresponding to the plurality of uplink information is used to transmit a transmission layer with a best quality of the target uplink information.

In some embodiments, the plurality of uplink information is transmitted by using an FDM transmission scheme or an SFN transmission scheme.

Optionally, In some embodiments, the above communication unit may be a communication interface or a transceiver, or an input and output interface of a communication chip or a system-on-chip. The above processing unit may be one or more processors.

It should be understood that the network device 500 according to the embodiments of the present application may correspond to the network device in the method embodiments of the present application, and the above and other operations and/or functions of various units in the network device 500 are respectively to implement the corresponding procedure of the network device of the method 200 shown in FIG. 3 to FIG. 5, which will not be repeated here for the sake of brevity.

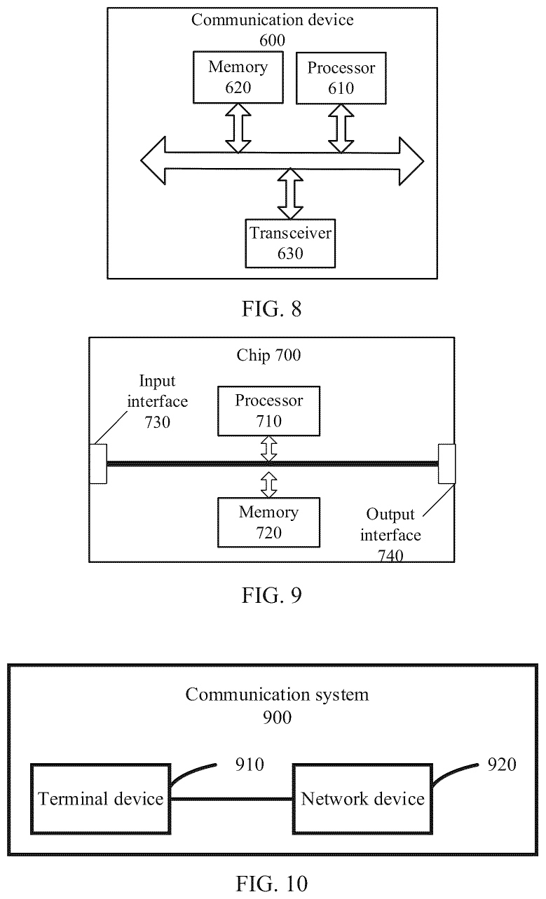

FIG. 8 is a schematic structural diagram of a communication device 600 provided in the embodiments of the present application. The communication device 600 shown in FIG. 8 includes a processor 610, which may invoke and execute a computer program from a memory, to implement the method in the embodiments of the present application.

Optionally, as shown in FIG. 8, the communication device 600 further includes a memory 620. Herein, the processor 610 may invoke and execute a computer program from the memory 620 to implement the method in the embodiments of the present application.

Herein, the memory 620 may be a separate device independent from the processor 610, or may also be integrated into the processor 610.

Optionally, as shown in FIG. 8, the communication device 600 may also include a transceiver 630, and the processor 610 may control the transceiver 630 to communicate with other devices, and for example, to transmit information or data to other devices, or receive information or data transmitted by other devices.

Herein, the transceiver 630 may include a transmitter and a receiver. The transceiver 630 may further include antennas, and the number of antennas may be one or more.

Optionally, the communication device 600 may be the network device of the embodiments of the present application, and the communication device 600 may implement the corresponding procedure implemented by the network device in the various methods of the embodiments of the present application, which will not be repeated here for the sake of brevity.

Optionally, the communication device 600 may be the mobile terminal/the terminal device of the embodiments of the present application, and the communication device 600 may implement the corresponding procedure implemented by the mobile terminal/the terminal device in the various methods of the embodiments of the present application, which will not be repeated here for the sake of brevity.

FIG. 9 is a schematic structural diagram of a chip of the embodiments of the present application. The chip 700 shown in FIG. 9 includes a processor 710, the processor 710 may invoke and execute a computer program from a memory to implement the method in the embodiments of the present application.

Optionally, as shown in FIG. 9, the chip 700 may further include a memory 720. Herein, the processor 710 may invoke and execute a computer program from the memory 720 to implement the method in the embodiments of the present application.

Herein, the memory 720 may be a separate device independent from the processor 710, or may also be integrated into the processor 710.

Optionally, the chip 700 may further include an input interface 730. Herein, the processor 710 may control the input interface 730 to communicate with other devices or chips, and for example, the input interface 730 may acquire information or data sent by other devices or chips.

Optionally, the chip 700 may further include an output interface 740. Herein, the processor 710 may control the output interface 740 to communicate with other devices or chips, and for example, the output interface 740 may output information or data to other devices or chips.

Optionally, the chip may be applied to the network device in the embodiments of the present application, and the chip may implement the corresponding procedure implemented by the network device in the various methods of the embodiments of the present application, which will not be repeated here for the sake of brevity.

Optionally, the chip may be applied to the mobile terminal/the terminal device in the embodiments of the present application, and the chip may implement the corresponding procedure implemented by the mobile terminal/the terminal device in the various methods of the embodiments of the present application, which will not be repeated here for the sake of brevity.

It should be understood that the chip mentioned in the embodiments of the present application may also be called a system on chip, a system chip, a chip system or a system-on-chip chip, etc.

FIG. 10 is a schematic block diagram of a communication system 900, provided by the embodiments of the present application. As shown in FIG. 10, the communication system 900 includes a terminal device 910 and a network device 920.

Herein, the terminal device 910 may be configured to implement the corresponding functions implemented by the terminal device in the above methods, and the network device 920 may be configured to implement the corresponding functions implemented by the network device in the above methods, which will not be repeated here for the sake of brevity.

It should be understood that the processor in the embodiments of the present application may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present application may be implemented or performed. A general-purpose processor may be a microprocessor, or the processor may also be any conventional processor, etc. The steps of the method disclosed in combination with the embodiments of the present application may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that, the memory in the embodiments of the present application may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, for example, the memory in embodiments of the present application may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present application is intended to include, but not limited to, these and any other suitable types of memories.

The embodiments of the present application further provide a non-transitory computer readable storage medium for storing a computer program.

Optionally, the non-transitory computer readable storage medium may be applied to the network device in the embodiments of the present application, and the computer program causes a computer to perform the corresponding procedure implemented by the network device in the various methods of the embodiments of the present application, which will not be repeated here for the sake of brevity.

Optionally, the non-transitory computer readable storage medium may be applied to the mobile terminal/the terminal device in the embodiments of the present application, and the computer program causes a computer to perform the corresponding procedure implemented by the mobile terminal/the terminal device in various methods of the embodiments of the present application, which will not be repeated here for the sake of brevity.

The embodiments of the present application further provide a computer program product including a computer program instruction.

Optionally, the computer program product may be applied to the network device in the embodiments of the present application, and the computer program instruction causes a computer to perform the corresponding procedure implemented by the network device in the various methods of the embodiments of the present application, which will not be repeated here for the sake of brevity.

Optionally, the computer program product may be applied to the mobile terminal/the terminal device in the embodiments of the present application, and the computer program instruction causes a computer to perform the corresponding procedure implemented by the mobile terminal/the terminal device in various methods of the embodiments of the present application, which will not be repeated here for the sake of brevity.

The embodiments of the present application further provide a computer program.

Optionally, the computer program may be applied to a network device in the embodiments of the present application, the computer program when being executed on a computer, causes the computer to perform the corresponding procedure implemented by the network device in various methods of the embodiments of the present application, which will not be repeated here for the sake of brevity.

Optionally, the computer program may be applied to the mobile terminal/the terminal device in the embodiments of the present application, the computer program when being executed on a computer, causes the computer to perform the corresponding procedure implemented by the mobile terminal/the terminal device in various methods of the embodiments of the present application, which will not be repeated here for the sake of brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on an application and a design constraint of the technical solution. A skilled person may use different methods for each application, to implement the described functions, but such implementation should not be considered beyond the scope of the present application.

It may be clearly understood by those skilled in the art that, for convenience and brevity of the description, the working procedures of the system, the apparatus and the unit described above may refer to the corresponding procedures in the above method embodiments, which will not be repeated here.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present application may be integrated into one processing unit, or the various units may exist physically separately, or two or more units may be integrated into one unit.

If the described functions are implemented in the form of a software functional unit and sold or used as an independent product, they may be stored in a non-transitory computer readable storage medium. Based on this understanding, the technical solution of the present application essentially, or a part of the technical solution that contributes to the prior art, or a part of the technical solution, may be embodied in the form of a software product, and the computer software product is stored in a storage medium, and includes a plurality of instructions for enabling a computer device (which may be a personal computer, a server, or a network device, etc.) to perform all or some of steps of the methods described in the various embodiments of the present application. And, the storage medium mentioned above includes a USB flash drive (U disk), a mobile hard disk, a Read-Only Memory (ROM), a Random Access Memory (RAM), a diskette, or an optical disk, and various mediums that may store program codes.

The above content is only exemplary implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A wireless communication method, wherein the method is applied to a terminal device, and comprises:
determining port information of a demodulation reference signal (DMRS) and/or transmission layer number information of a plurality of uplink information according to target antenna port indication information, wherein the plurality of uplink information is associated with different spatial parameters, and the plurality of uplink information comprises first uplink information and second uplink information.

2. The method according to claim 1, wherein the target antenna port indication information comprises fourth antenna port indication information, and the determining the port information of the demodulation reference signal (DMRS) and/or the transmission layer number information of the plurality of uplink information according to the target antenna port indication information, comprises:
determining port information of a first DMRS and port information of a second DMRS according to the fourth antenna port indication information;
wherein the first DMRS is associated with the first uplink information, and the second DMRS is associated with the second uplink information.

3. The method according to claim 2, wherein the determining the port information of the first DMRS and the port information of the second DMRS according to the fourth antenna port indication information, comprises:
determining the port information of the first DMRS and the port information of the second DMRS according to the fourth antenna port indication information and a fourth transmission parameter;
wherein the fourth transmission parameter comprises a transmission parameter of the first uplink information and a transmission parameter of the second uplink information.

4. The method according to claim 3, wherein the fourth transmission parameter comprises at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
wherein the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.

5. The method according to claim 3, wherein the determining the port information of the first DMRS and the port information of the second DMRS according to the fourth antenna port indication information and the fourth transmission parameter, comprises:
determining a third correspondence in a plurality of correspondences according to a sum of a first number of layers and a second number of layers, wherein the plurality of correspondences correspond to different numbers of transmission layers, respectively, the third correspondence corresponds to the sum of the first number of layers and the second number of layers, and the third correspondence comprises a correspondence between a state value of antenna port indication information, and port information of the first DMRS and port information of the second DMRS;
determining the port information of the first DMRS and the port information of the second DMRS according to the fourth antenna port indication information and the third correspondence.

6. The method according to claim 1, wherein the plurality of uplink information is transmitted by using a spatial division multiplexing (SDM) transmission scheme.

7. A terminal device, comprising: a processor and a memory, wherein the memory is configured to store a computer program, the processor is configured to invoke and execute the computer program stored in the memory, to cause the terminal device to perform:
determining port information of a demodulation reference signal (DMRS) and/or transmission layer number information of a plurality of uplink information according to target antenna port indication information, wherein the plurality of uplink information is associated with different spatial parameters, and the plurality of uplink information comprises first uplink information and second uplink information.

8. The terminal device according to claim 7, wherein the target antenna port indication information comprises fourth antenna port indication information, and the terminal device performs:
determining port information of a first DMRS and port information of a second DMRS according to the fourth antenna port indication information;
wherein the first DMRS is associated with the first uplink information, and the second DMRS is associated with the second uplink information.

9. The terminal device according to claim 8, wherein the terminal device performs:
determining the port information of the first DMRS and the port information of the second DMRS according to the fourth antenna port indication information and a fourth transmission parameter;
wherein the fourth transmission parameter comprises a transmission parameter of the first uplink information and a transmission parameter of the second uplink information.

10. The terminal device according to claim 9, wherein the fourth transmission parameter comprises at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
wherein the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.

11. The terminal device according to claim 9, wherein the terminal device performs:
determining a third correspondence in a plurality of correspondences according to a sum of a first number of layers and a second number of layers, wherein the plurality of correspondences correspond to different numbers of transmission layers, respectively, the third correspondence corresponds to the sum of the first number of layers and the second number of layers, and the third correspondence comprises a correspondence between a state value of antenna port indication information, and port information of the first DMRS and port information of the second DMRS;
determining the port information of the first DMRS and the port information of the second DMRS according to the fourth antenna port indication information and the third correspondence.

12. The terminal device according to claim 7, wherein the plurality of uplink information is transmitted by using a spatial division multiplexing (SDM) transmission scheme.

13. A network device, comprising: a processor and a memory, wherein the memory is configured to store a computer program, the processor is configured to invoke and execute the computer program stored in the memory, to cause the network device to perform:
transmitting target antenna port indication information to a terminal device, wherein the target antenna port indication information is used by the terminal device to determine port information of a demodulation reference signal (DMRS) and/or transmission layer number information of a plurality of uplink information, the plurality of uplink information is associated with different spatial parameters, and the plurality of uplink information comprises first uplink information and second uplink information.

14. The network device according to claim 13, wherein the target antenna port indication information comprises fourth antenna port indication information, and the fourth antenna port indication information is used to determine port information of a first DMRS and port information of a second DMRS, wherein the first DMRS is associated with the first uplink information, and the second DMRS is associated with the second uplink information.

15. The network device according to claim 14, wherein the port information of the first DMRS and the port information of the second DMRS are determined according to the fourth antenna port indication information and a fourth transmission parameter, wherein the fourth transmission parameter comprises a transmission parameter of the first uplink information and a transmission parameter of the second uplink information.

16. The network device according to claim 15, wherein the fourth transmission parameter comprises at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
wherein the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.

17. The network device according to claim 13, wherein the plurality of uplink information is transmitted by using a spatial division multiplexing (SDM) transmission scheme.

18. A wireless communication method, wherein the method is applied to a network device according to claim 13, and comprises:
transmitting target antenna port indication information to a terminal device, wherein the target antenna port indication information is used by the terminal device to determine port information of a demodulation reference signal (DMRS) and/or transmission layer number information of a plurality of uplink information, the plurality of uplink information is associated with different spatial parameters, and the plurality of uplink information comprises first uplink information and second uplink information.

19. The method according to claim 18, wherein the target antenna port indication information comprises fourth antenna port indication information, and the fourth antenna port indication information is used to determine port information of a first DMRS and port information of a second DMRS, wherein the first DMRS is associated with the first uplink information, and the second DMRS is associated with the second uplink information.

20. The method according to claim 19, wherein the port information of the first DMRS and the port information of the second DMRS are determined according to the fourth antenna port indication information and a fourth transmission parameter, wherein the fourth transmission parameter comprises a transmission parameter of the first uplink information and a transmission parameter of the second uplink information;
wherein the fourth transmission parameter comprises at least one of:
a sum of a first number of layers and a second number of layers, a type of the first DMRS, a maximum number of symbols of the first DMRS, a type of the second DMRS, a maximum number of symbols of the second DMRS, or a number of DMRS CDM groups;
wherein the first number of layers, the type of the first DMRS, and the maximum number of symbols of the first DMRS are associated with the first uplink information, and the second number of layers, the type of the second DMRS, and the maximum number of symbols of the second DMRS are associated with the second uplink information.
